(19) United States
(12) Patent Application Publication
(10) Pub. No.: US 2024/0349933 A1
(43) Pub. Date: Oct. 24, 2024

(54) SINGLE SERVING POD FOR USE IN BEVERAGE FORMING SYSTEM TO MAKE PREPARED BEVERAGE WITH HYDRODYNAMIC MIXING AND BEVERAGE FORMING SYSTEM THEREOF

(71) Applicant: HEALTHY CONCEPTS dba EASYSHAKE, MANHATTAN BEACH, CA (US)

(72) Inventor: BRIAN J. KORDICH, MANHATTAN BEACH, CA (US)

(73) Assignee: HEALTHY CONCEPTS dba EASYSHAKE, MANHATTAN BEACH, CA (US)

(21) Appl. No.: 18/760,212

(22) Filed: Jul. 1, 2024

Related U.S. Application Data
(63) Continuation-in-part of application No. 17/125,907, filed on Dec. 17, 2020, now Pat. No. 12,064,051.

(51) Int. Cl. A47J 31/40; A47J 31/44; A47J 31/46; B65D 85/804

(52) U.S. Cl. CPC A47J 31/407; A47J 31/4403; A47J 31/468; B65D 85/8046

(57) ABSTRACT

A pod for use in a beverage forming system makes a prepared beverage solely by hydrodynamic mixing of a beverage material residing in an interior space of a body of the pod with a pressurized liquid introduced therein by the beverage forming system. A water vein element in the pod body receives the pressurized liquid, which exits out a plurality of spaced holes formed therein up and down and around a circumference thereof. The pressurized liquid exits these holes as an array of water jets creating hydrodynamic-based kinetic energy to impart turbulent flow so as to mix with the beverage material with the water jest in the interior and create the prepared beverage that is vented into a cup. No other source of mechanical, thermal, vibrational, and aerodynamical kinetic energy is needed for agitation of the beverage material with the array of water jets.

### CROSS-REFERENCE TO RELATED APPLICATION

The present application is a continuation-in-part of and claims the benefit under 35 U.S.C 120 to U.S. patent application Ser. No. 17/125,907 to Kordich, et al., filed Dec. 17, 2020, pending, the entire contents of which is hereby incorporated by reference herein.

### BACKGROUND

### Field

The example embodiments are directed to a single serving pod for use in a beverage forming system to make a prepared beverage with hydrodynamic mixing, and to a beverage forming system thereof.

### Related Art

Cartridge-based beverage forming systems that use a liquid, such as water, to form a prepared beverage are well known, examples including various beverage machines (such as those known under the KEURIG® or NESPRESSO® brands) which include a cartridge holder that is adapted to receive a single-use beverage cartridge or pod containing beverage material (i.e., coffee grounds, powdered drink mix) to make the prepared beverage. Typically, this is done by puncturing the cartridge at the top and bottom so as to introduce liquid into the cartridge to mix with the beverage material contents inside, the prepared beverage thus formed inside and exiting the cartridge or “pod” into a cup. Liquid provided to the cartridge may or may not be heated in a tank prior to delivery to the cartridge.

Protein powders contain protein and fat molecules that naturally attract and easily absorb a greater volume of fluid prior to their full-saturation point. These hydrophilic particles act differently in water than other powdered substances (such as coffee grounds and powdered sugar drinks such as hot cocoa mix). Even when anti-clumping additives and super disintegrates like lecithin, silicon dioxide, or microcrystalline cellulose are used, it can be difficult to produce a smooth consistency that is acceptable to the consumer. This is especially true when mixing a protein drink from a protein powder concentrate without using any form of conventional agitation. Conventional agitation methods for beverages include mechanical agitation, thermal agitation (heat transfer or chemical bonds (such as filtered coffee or heated infant beverage forming system)), vibrational/sound-based agitation, gas charged or gas-infused (i.e., aerodynamic fluid-based) agitation (such as systems using gas chargers to make fizzy drinks and shakes) or gravitational agitation to remove or physically break-up the clumps that often form when mixing a protein drink.

The clumps that may form when mixing hydrophilic powders do not affect the efficacy or quality of the protein powder, but may deter consumers from enjoying the protein-based beverages to a point where they will not regularly use the product. Furthermore, the process of manually mixing the protein powder with a liquid by shaking can by physically demanding, and it's difficult to tell whether all the clumps are gone when looking through a protein drink, since it is often a non-transparent suspended solution. As just one example, when using mechanical agitation, the necessity to clean components used during the mixing process (e.g., a blender) is often a sufficient enough deterrent for some protein powder drink consumers.

While the goal of “smooth-consistency mixing” exists for every protein powder drink made, the manufacturers of protein powder do not provide a quantitative method of assessing if “complete mixing” has been achieved. In the proposed solution, “complete mixing” is defined as mixing substantially most of a powder from the pod with some minimal residue being possibly left behind inside the pod.

FIGS. 1A through 1E illustrate photographs of a conventional, semi-cylindrical non-expanding transparent test beverage pod at different stages in a beverage mixing process of a protein powder with water and an exit of the mixed beverage out of a pod 10. Beginning with FIG. 1A, the powder contents gradually mix with an entering liquid under pressure (such as water, see FIGS. 1A-1C which show water entering pod 10 and the mixing process reaching the full saturation point in FIG. 1C). FIG. 1D shows an intermediate draining stage of the mixed beverage with the water spike removed and FIG. 1E shows the transparent test pod 10 after the mixed beverage has completely exited the pod 10.

FIG. 2 is a photograph of a similar conventional test pod after a failed test. In FIG. 2, not all of the mixed beverage has not all exited the pod 10, and a boundary layer has formed due to improper mixing methods or pump pressure/runtime parameters.

The pod 10 shown in FIGS. 1A through 1E and FIG. 2 are representative of a typical, conventional sealed cartridge that contains beverage forming material therein, with the shape of the pod changing from a semi-cylinder to a sphere-shape in some embodiments. FIG. 2 demonstrates that the water spike and pod-shape configurations according to the conventional art are carefully refined for each powdered application, because a trivial beverage pod assembly will result in the liquid not being properly distributed within the pod, causing clumps of unmixed powder (shown in region B of FIG. 2) to form, resulting in an unsuccessful mixing process.

The clumping issue is compounded when a protein powder concentrate is contained completely within the sealed cartridge or pod for use in one of the aforementioned beverage forming systems, since they are hydrophilic particles unlike other beverage pods that are currently available. As noted, due to the nature of the composition of the hydrophilic protein powder, the powder is more prone to “clumping” within the cartridge or pod during the mixing process. As shown in FIG. 2, these clumps can often form in large pockets as the result of the creation of boundary layers (layers of saturated powder (see region A) next to large areas of non-saturated powder (see region B)).

Accordingly, when a region of powder in one portion of the pod dissolves away prematurely, it allows the incoming water to follow a path of least-resistance through the already dissolved-away internal-channel as the mixed beverage exits the pod 10. This ultimately results in an improper (or incompletely) mixed solution in the conventional beverage pod (such as is shown in FIG. 2), leaving behind completely dry (non-saturated) regions of powder that are trapped behind the saturated-powder boundary layers.

Thus, what is needed is a cartridge or pod-based beverage forming system which utilizes a pod or cartridge that, without employing the conventional agitation methods (e.g., mechanical, thermal, vibrational, gas charged, or gravitational-based agitation) inside the pod, eliminates the clumping issue when mixing liquids with protein powder and/or other nutritional or foodstuff powders therein. Such a system and pod would thus permit complete mixing of contents inside the pod for exiting of all contents therefrom into a drinking vessel such as a cup, thereby providing a completely empty and recyclable pod.

### SUMMARY

An example embodiment of the present invention is directed to a pod for a beverage forming system to make a prepared beverage by hydrodynamic mixing of a beverage material subject to clumping with a pressurized liquid introduced into the pod by the beverage forming system. The pod includes a body having a top end, bottom end, and an interior space, and an elongate water vein element having a hollow interior and disposed within the interior space for receiving the pressurized liquid used for hydrodynamic mixing. An upper end of the water vein element has a central opening therein aligned with an opening in the beverage forming system that, upon initiation of a mixing process, provides access for the pressurized liquid to flow into the hollow interior of the water vein element. The pressurized liquid exits the water vein element into the interior space of the body as an array of water jets, creating hydrodynamic-based kinetic energy to impart turbulent flow within the interior space so as to rapidly saturate the beverage material and form the prepared beverage prior to any forming of clumps in the beverage material. The body further includes an exit hole at the bottom end thereof, the prepared beverage vented through the exit hole into a cup arranged beneath the pod in the beverage forming system.

Another example embodiment is directed to a pod for a beverage forming system to make a prepared beverage by hydrodynamic mixing of a liquid solute with over 1% insoluble content with a pressurized liquid that is introduced into the pod by the beverage forming system. The pod includes a body having a top end, bottom end, and an interior space, and an elongate, water vein element having a hollow interior and disposed within the interior space, for receiving the pressurized liquid used for hydrodynamic mixing. A top open end of the water vein element is aligned with an opening in the beverage forming system so that, upon initiation of a mixing process, it provides access for the pressurized liquid to flow into the hollow interior of the water vein element. The pressurized liquid exits the water vein element into the interior space of the body as an array of water jets creating hydrodynamic-based kinetic energy to impart turbulent flow within the interior space to agitate the liquid solute with over 1% insoluble content and form the prepared beverage. The body further includes an exit hole at the bottom end thereof, the prepared beverage vented through the exit hole into a cup arranged beneath the pod of the beverage forming system.

Another example embodiment is directed to a beverage forming system for making a prepared beverage by hydrodynamic mixing of a pod containing a beverage material subject to clumping within an interior space of a body of the pod with a pressurized liquid introduced into the interior space thereby. The system includes a housing, at least one reservoir attached to the housing and containing a liquid therein, and a mixing chamber accessible on the housing for loading the pod containing the beverage material therein. The pod body has a central opening at a top end thereof and an exit hole in a bottom end thereof. The mixing chamber is connected to a source that pressurizes the liquid drawn from the at least one reservoir for hydrodynamic mixing of the pressurized liquid and the beverage material within the interior space. A platform in the housing supports a cup directly beneath the mixing chamber. The pressurized liquid, when introduced into the central opening of the pod body, forms an array of water jets that creates hydrodynamic-based kinetic energy to impart turbulent flow within the pod to rapidly agitate the beverage material and form a uniformly dispersed prepared beverage that is vented through the exit hole into the cup on the platform.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIGS. 1A through 1E are photographs of a transparent conventional test beverage pod during stages in a test process of successfully mixing a protein powder with water to form a beverage. The water vein element has been removed during the draining process (FIGS. 1D and 1E) to demonstrate that incoming water has stopped.

FIG. 2 is a photograph of a similar conventional art test pod after a failed test, where the mixed beverage has not all exited the pod, and a boundary layer has formed due to improper mixing methods or pump pressure/runtime parameters.

FIG. 3 is a front transparent plan view of a beverage forming system with single serving pod according to the example embodiments.

FIG. 4 is a front perspective view of the beverage forming system shown in FIG. 3 but with the top cover and housing removed to show interior components thereof.

FIG. 5 is a front plan view of the beverage forming system shown in FIG. 3 but with the top cover and housing removed to show interior components thereof.

FIG. 6 is a rear perspective view of the beverage forming system shown in FIG. 3 but with the top cover and housing removed to show interior components thereof.

FIG. 7 is an enlarged front plan view of the mixing chamber in the system of FIG. 3 with the single-serving pod inserted for use therein.

FIG. 8 is a right-side elevational view of the mixing chamber shown in FIG. 7

FIG. 9 is a cross-sectional view taken across line C-C of FIG. 8 to illustrate additional components of the mixing chamber in more detail.

FIG. 10 is a top perspective view of the mixing chamber of FIG. 7 with the single-serving pod inserted therein to illustrate a loading operation.

FIG. 11 is an exploded-parts view of single serving pod according to the example embodiments.

FIG. 12 is a perspective view of the pod of FIG. 11 with the flange and attached water vein element removed to illustrate a lower portion of the pod.

FIG. 13 is a perspective view of the pod of FIG. 11 with the pod body removed to illustrate an upper portion of the pod.

FIG. 14 is a bottom plan view of the upper portion of the pod shown in FIG. 13 to illustrate certain structure in more detail.

FIG. 15 is a bottom plan view of the complete pod shown in FIG. 11 to illustrate certain structure in more detail.

FIG. 16 is a cross-sectional view taken across line D-D of FIG. 15 to illustrate the single serving pod prior to hermetic sealing within the mixing chamber.

FIG. 17 is a cross-sectional view similar to FIG. 16 and indicates mating portions to the mixing chamber to illustrate the single serving pod as being hermetically sealed within the pod holder of the mixing chamber.

FIG. 18 is a transparent front plan view of the single serving pod to help illustrate equal thickness positioning of the interior wall distance from the exit hole in the pod to the lower end of the water vein element.

FIG. 19 is a front plan view of the upper portion to provide a visual representation of equally spaced row height as it corresponds to the plurality of equispaced radial holes along the water vein element.

FIG. 20 is a photograph of a flow test of the upper portion of the example pod with water vein element to demonstrate good or desirable water flow distribution of the water jets up the majority of the length of the water vein element without applied back-pressure, according to the example embodiments.

FIG. 21 is a photograph of a flow test of an upper portion of a pod with different hole locations in the water vein element to demonstrate poor water flow distribution of the water jets without applied back-pressure.

FIG. 22 is front plan view of the example single serving pod to show equal thickness positioning of interior wall distance to points along the water vein element sides across the bottom portion of the pod.

FIG. 23 is a top plan view of the example single serving pod to show equal radial positioning of the hollow water vein element across the upper portion of the pod.

FIG. 24 is the front plan view of the beverage forming system originally shown in FIG. 5 but indicating a location for a secondary reservoir for direct connection to the example single serving pod.

FIG. 25 is a rendering of an example secondary reservoir design for the location shown in FIG. 24, allowing for the containment of perishable liquids.

FIG. 26 is a right-side elevational view of the cross-sectional view of FIG. 9, which was taken across line C-C of FIG. 8 to illustrate potential placement of a secondary vacuum pump in more detail.

FIG. 27 is a partial perspective view of part of the lower portion of the example pod to illustrate a turbulence grid usable to increase fluid agitation while prepared beverage exits the example pod via the exit hole.

FIG. 28 is a top plan view of the pod lower portion to show the turbulence grid of FIG. 27 in more detail.

FIG. 29 is a partial perspective view of part of the lower portion of the example pod to illustrate flow lines according to Bernoulli's equation principles for increasing prepared beverage exit velocity from the pod via the exit hole.

FIG. 30 is a transparent front view of a single serving pod according to another example embodiment to illustrate a multiple internal-cavity design for the lower portion of the pod around the water vein element.

FIG. 31 is a transparent front view of a single serving pod according to another example embodiment to illustrate a multiple internal-cavity design for the lower portion of the pod around the water vein element slightly different than what is shown in FIG. 30.

FIG. 32 is a top plan view of a single serving pod according to yet another example embodiment to illustrate a multiple internal-cavity design different than what is shown in FIGS. 30 and 31.

FIG. 33 is a partial exploded parts perspective view of an expandable pod according to another example embodiment in order to show components in more detail.

FIG. 34 is a another perspective view of the pod of FIG. 33 to show details thereof.

FIG. 35 is a cross-sectional view taken across line C-C of FIG. 34 to show the expandable in a pre-expansion state.

FIG. 36 is another cross-sectional view taken across line C-C of FIG. 34 similar to FIG. 35, showing the state of the expandable pod after pressurized expansion due to internal pod pressures.

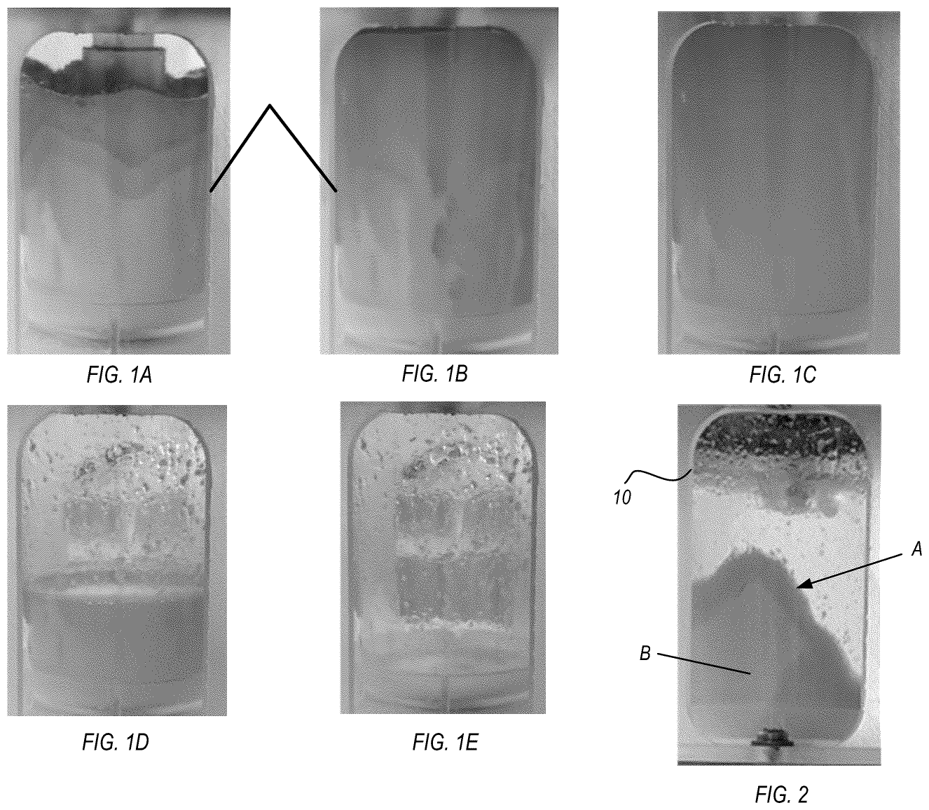

### DETAILED DESCRIPTION

In the following description, certain specific details are set forth in order to provide a thorough understanding of various example embodiments of the disclosure. However, one skilled in the art will understand that the disclosure may be practiced without these specific details. In other instances, well-known structures associated with manufacturing techniques have not been described in detail to avoid unnecessarily obscuring the descriptions of the example embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise.

As used in the specification and appended claims, the terms “correspond,” “corresponds,” and “corresponding” are intended to describe a ratio of or a similarity between referenced objects. The use of “correspond” or one of its forms should not be construed to mean the exact shape or size. In the drawings, identical reference numbers identify similar elements or acts. The size and relative positions of elements in the drawings are not necessarily drawn to scale.

As to be described in more detail hereafter, the example embodiments hereafter describe a single serving pod for use in a beverage forming system to make a prepared beverage via hydrodynamic mixing, and to a beverage forming system thereof. More particularly, the single serving pod usable in the beverage forming system makes a prepared beverage solely by hydrodynamic mixing of a beverage material (which normally is subject to clumping when saturated by a liquid) residing within the pod body with a pressurized liquid that is introduced into the pod body interior by the beverage forming system.

Namely, and as to be shown hereafter, the pod body interior includes an elongate, hollow water vein element that, upon initiation of a mixing process by the beverage forming system, receives the pressurized liquid therein at an open top end thereof. This water vein element includes a plurality of holes arranged in spaced relation to one another along a longitudinal plane of the water vein element from top to bottom thereof, as well as around a circumference of the water vein element from top to bottom thereof. The pressurized liquid exits the plurality of holes as an array of water jets that create the hydrodynamic-based kinetic energy to impart the turbulent flow in the interior space of the pod body and mix with the beverage material therein to create the prepared beverage.

The array of water jets include multiple water jets shooting radially outward at multiple locations from sides of the water vein element, multiple water jets shooting at an angle downward relative to a horizontal plane through the water vein element sides toward the pod bottom end, and multiple water jets shooting directly downward towards an exit hole at the bottom end of the pod. Complete mixing of the beverage material with the array of water jets is a function of several variables. These variables or factors include, but not limited to: spacing between holes in the water vein element; a size diameter of the holes; water jet velocity out each hole; and overall liquid fluid flow rate of the pressurized liquid entering the water vein element.

In at least one example, as to be shown hereafter, there is one, some, or all of (a) setting of a distance from the exit hole in the pod to the lower end or bottom of the water vein element where a plurality of downward facing holes are located, (b) equally spaced row height as it corresponds to the plurality of equispaced radial holes up, down and around the sides of the water vein element to promote the uniform radial distribution of water jets, and (c) equal radial positioning of interior wall distance to points along and around the water vein element sides to promote the uniform radial distribution of water jets.

Thus, and unlike all other conventional beverage forming systems, hydrodynamic kinetic energy generated within the single serving pod is the sole source for mixing the beverage material with the liquid in the pod. Hence, neither the pod nor the beverage forming system described hereafter requires or uses any other mixing source (i.e., mechanical, thermal, vibrational, and/or aerodynamical kinetic energy source (either external or internal to the pod and/or to a mixing chamber of the beverage forming system which contains the pod therein)), to agitate the beverage material with the pressurized liquid in order to induce mixing thereof to create the prepared beverage.

In the following example embodiments, the beverage material in one variant is a powder-based beverage material comprising any of juice powder mixes, vitamin mixes, sports drink powder mixes, instant coffee mixes, and other beverage materials which are over 99% soluble in water. The example embodiments also use any powder-based beverage material comprising any of protein powders, other nutritional powders, and foodstuff powders that are less than 99% water-soluble (i.e., powdered milk or powdered foodstuff, juice) when mixed in a liquid to form a prepared beverage. Further, the example embodiments are applicable to a beverage material variant embodied as a liquid-based beverage material comprising solids suspended or precipitated within water, as well as to any other beverage material that is greater than 1% water insoluble when mixed in water to form a prepared beverage.

In one specific example, the beverage forming system described hereafter may be embodied as a pod-based protein powder drink machine which requires minimal cleanup. Pods usable therein may be fully recyclable and include existing powder contents therein that are applicable to sports nutrition. Powders such as these are commonly hydrophilic in nature and usually difficult to mix smoothly without external or internal mechanical agitation to breakup clumps that innately form.

Accordingly, the example design for the pod and for the beverage forming system described hereafter is unique due to one intended purpose of mixing hydrophilic particles (which are prone to clumping) entirely within the pod using hydrodynamic mixing as the source of kinetic energy for mixing. In some cases, alternative pod embodiments such as expandable-volume pods could be used for hydrodynamic mixing of the beverage material and pressurized liquid, instead of a fixed volume pod body construction.

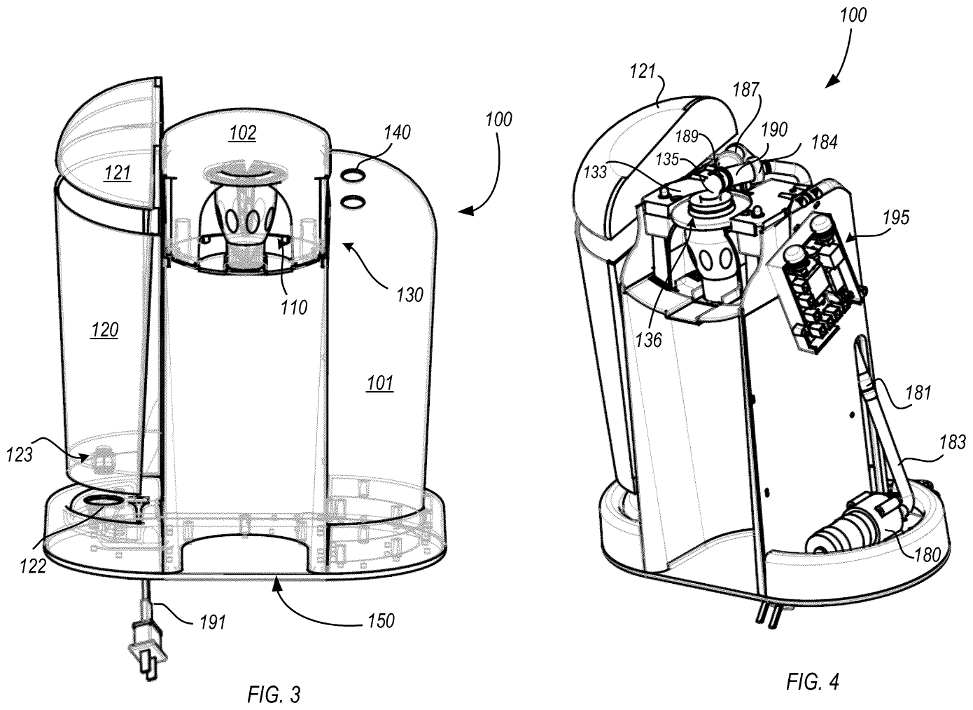

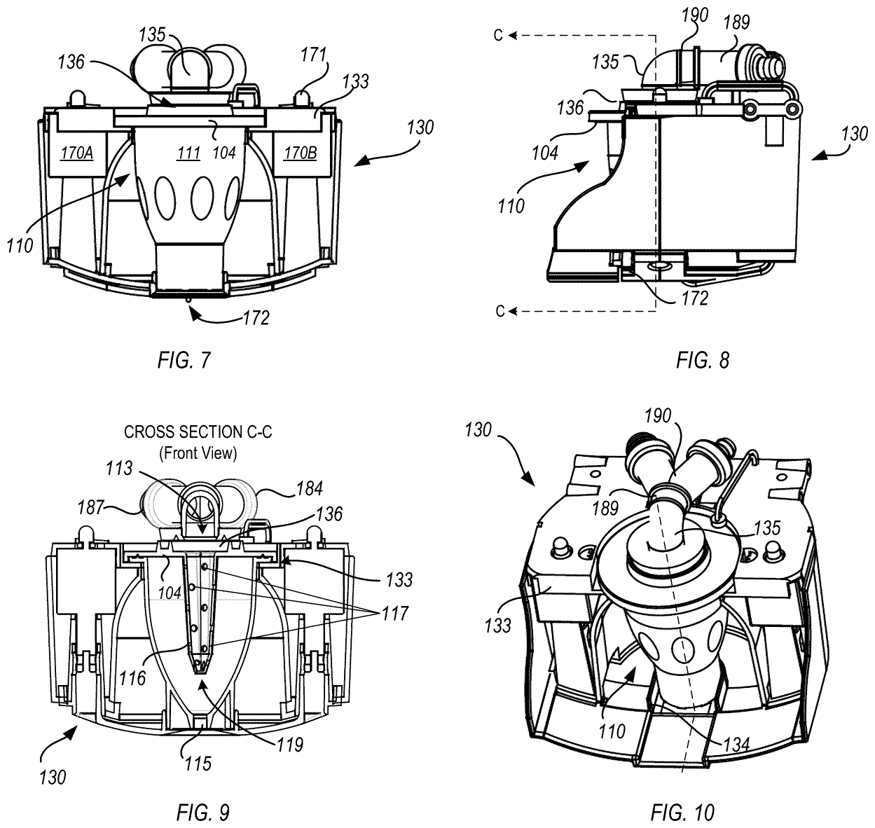

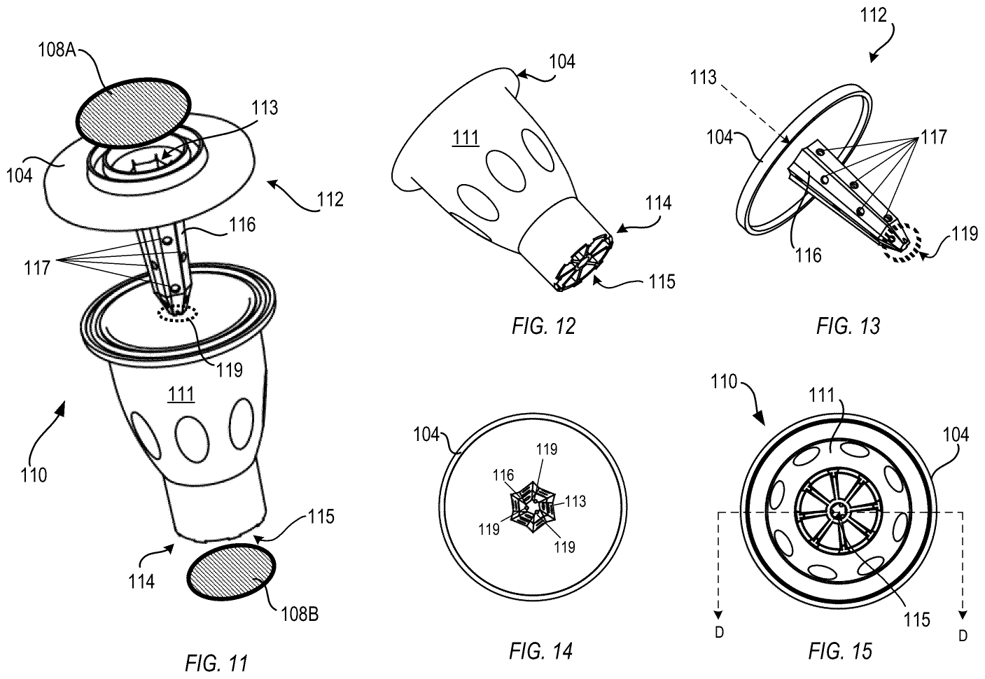

FIGS. 3 to 6 illustrate an example beverage forming system 100 adapted for use with a single serving beverage pod assembly (hereafter “pod 110”) (as well as in an alternative, for use with a reusable and recyclable pod) according to the example embodiments; FIGS. 7-10 show various features and operations regarding pod 110 within a mixing chamber 130 of the beverage forming system 100; and FIGS. 11-23 show various features of the single-serving pod 110 in more detail.

With reference now to FIGS. 3-10, system 100 may include an exterior housing 101 (hereafter “housing 101”) which contains or supports a removable primary reservoir 120 designed to hold or be filled with water, and an optional removable secondary reservoir 124 (not shown in FIGS. 3-23 but described hereafter) designed to hold or be filled with liquids other than water (i.e., milk, juice, other). To remove the reservoir 120 for refilling, a reservoir lid 121 is lifted and the primary reservoir 120 is vertically removed out of its seal 122 to separate it from housing 101. A spring-loaded reservoir plug 123 may be used to prevent the removable primary reservoir 120 from leaking during the refilling process.

A water pump 185 for pressurizing a liquid may be arranged in the housing 101 along with an air pump 180 that provides additional pressure and assists with the draining process. The water pump 185 may have a suction or intake line 188 connected to the removable primary reservoir 120 (and/or to the removable secondary reservoir 124). As shown best in FIG. 6, the water pump 185 has an exit line 186 that is connected at its distal end to a Y-connector 190. The Y-connector 190 is what combines the air (from air pump exit line 183) and water in exit line 186 that are to about be pumped into the mixing chamber 130 through an inlet line 189 that is connected to the central opening 113 of the pod 110.

In an example, a food-grade air filter 181 may be used with air pump 180 to purify the air of particulates prior to introducing it to the water for mixing therewith at the base of Y-connector 190. Namely, Y-connector 190 carries the water through a top cover 102 into inlet line 189 within the mixing chamber 130 and pumps it out through fluid exit nozzle 135 into the central opening 113 at the upper portion or top end 112 of the pod 110. Once the fluid exit nozzle 135 is closed onto the top half of the pod 112, a connection is therefore established at the distal end of the water pump exit line 186 to the upper end of the water vein element 116 at the central opening 113 in pod 110, via Y-connector 190 and inlet line 189.

FIG. 10 is provided to describe a loading operation for the pod 110 within mixing chamber 130. Loading of pod 110 may be via an access or opening in the front of the mixing chamber 130. As an example, the mixing chamber 130 could be embodied as a front-loading mixing chamber 130 of FIG. 10 (also depicted in FIGS. 3 to 5). Here, an opening in the front portion of mixing chamber 130 is shaped like (to receive) the pod 110 that is intended to be used, so a user knows how to operate it intuitively. This has functional advantages over conventional axial loading (like a K-CUP®), where the user would otherwise have to remove the system from underneath a cupboard in order to be able to insert the pod (if it were a top-loading design), or where top cover flips open as known in a KEURIG brewing chamber. With the top-loading design, alignment of the pod within the KEURIG is almost guaranteed to be precisely axially-aligned due to the telescoping-natured design of the K-CUP insertion process into its brewing chamber.

While this method of loading might remove design challenges for alignment techniques necessary for the KEURIG mixing chamber, it comes at the sacrifice of user experience when placing the KEURIG at the necessary height required to load and unload the pod into the mixing chamber. Instead of taking this technical shortcut, system 100 employs a front-loading solution for pod 110, which allows users to leave the system 100 unmoved during use. As seen in FIG. 10, the low-lying system-height functionality is enabled by the front-loading mixing chamber 130 design, a non-trivial aspect to overlook.

For the front-loaded mixing chamber 130 to accommodate pod 110, the receptacle profile matches the pod 110 shape, and more particularly the flange 104 in the upper portion or top end 112 of pod 110, as shown in FIG. 10. In general, the pod size for mixing powdered beverages should be larger than typical K-CUPs, because one serving of these powder beverage mixes is generally larger in size than one serving of solid filtered ingredients (coffee, tea) which would be used to infuse a brewed filtered beverage as done by a KEURIG machine.

As demonstrated in tests by the Applicant, powdered beverage materials are more difficult and less-trivial to mix within systems like KEURIG; this may lead the public to believe that those products offered for their beverage forming systems do not work consistently to fully-dispense and fully-mix the contents of the powdered beverage material. Furthermore, powdered beverage materials (especially those with >1% insoluble material content) often experience higher clumping rates within relatively smaller mixing container volumes. This is why Applicant, in their original or parent application Ser. No. 17/125,907 to Kordich, et al., the entire contents of which is incorporated by reference herein (hereafter the “'907 application”) described use of an expanding-volume version of the single serving pod 110 for a specific use of harder-to-mix >1% insoluble beverage materials.

Mixing chamber 130 may include an opening or receptacle area for the pod 110 to rest upon (hereafter “pod holder 133”) configured and dimensioned to receive a beverage pod 110 therein. A fixed frame for supporting the pod holder 133 is contained within mixing chamber 130, sitting on housing 101. The mixing chamber 130 can support the pod holder 133 from the top, but allows for pivotal movement about a first axis that is aligned with the center vertical axis of the pod 110 once loaded in the pod holder 133.

For a front-loaded mixing chamber such as chamber 130 to accommodate pod 110, another example construction for the mixing chamber could be as a modification of a brew chamber designed by KEURIG for their K-CUP system, namely a modification of the receptacle profile to match the pod 110 shape. In general, the pod size for mixing hydrophilic powders should be larger because these powder particles are difficult to mix and often experience higher clumping rates in smaller relative volumes, which is why an expanding-volume pod 110 is described herein.

Fluid exit nozzle 135 in an example is articulated and may be supported on the frame of mixing chamber 130 or pod holder 133 for pivotal movement about a second axis between a raised position (“open”) which allows access to pod holder 133 for loading and unloading of pods, and a lowered position closing the nozzle shaped ring seal 136 down into its vertically aligned mixing position, which creates a seal between the fluid exit nozzle 135 of mixing chamber 130 and central opening 113 within the flange 104 of the pod 110. The first and second axes may be parallel or perpendicular (as in this example) depending on the desired construction of system 100.

In an example embodiment, a linkage may be provided to connect the pod-holder 133 to the mixing chamber 130 and an articulating top cover 102. The linkage may serve to pivotally connect the different pieces such that the user may manipulate the top cover 102 between open and closed (mixing) positions in response to movement of the top cover 102 between its raised and lowered positions. This manipulation could be designed to seal the fluid exit nozzle 135 to the central opening 113 on the top of the pod 110 via ring shaped seal 136, which comes into contact when the top cover 102 is closed.

Once the pod 110 is loaded in the pod holder 133 of the mixing chamber 130 initiation of a mixing process is possible by a user manually, or automated via a control button at a control panel 140. Generally, the mixing process enables liquid from the removable primary reservoir 120 to be pressurized and ported via the water pump 185 through water pump exit line 186 and into Y-connector 190, then through inlet line 189 to flow out of the fluid exit nozzle 135 and into the top end 112 of pod 110 at central opening 113. The mixing process is described in more detail hereafter.

This control panel 140 or control interface (such as an LCD panel or other button interface) is provided for system 100 operation (system on/off, initiating the mixing process, display of system indicator signals/lights, etc.) An access port to the housing 101, commonly described as a cup receptacle area 150 is provided within the housing 101 so as to place a cup or bottle therein for receiving mixed beverage contents which are exiting the pod 110 within the mixing chamber 130 via an exit hole 115 arranged at the bottom end 114 of the pod 110.

Incoming power to the system 100 is provided by an AC power cable 191, which can be stored in an embedded opening in housing 101 so-as to minimize its storage footprint when not in use, similar to other household appliances (not pictured). AC power cable 191 supplies incoming power to a motor drive and power control PCB 195, which also receives user-inputs from control panel 140 and sends the corresponding system indicator light signals back to control panel 140 for display to the user.

Thus, once the pod 110 is loaded in the pod holder 133 or mixing chamber 130, initiation of a mixing process is possible by a user automated via a control button at a control panel 140. This enables liquid from the removable primary reservoir 120 to be pressurized and ported via the water pump 185 through water check valve 187 to mix in with air ported from the air pump 180 up its exit line 183 and through air check valve 184 to mix with the water so as to realize the pressurized liquid at a Y-connector 190 and inlet line 189, the pressurized liquid (air-water mix) exiting out fluid exit nozzle 135 and into the top of pod 110 through the central opening 113. System 100 may include well-known types of upper sensors 171 and a bottom sensor 172 for the mixing chamber 130 to detect if the pod 110 has been properly loading into place or not.

In the example embodiments, mixing is performed entirely within the pod 110, but without any internal or external mechanical, thermal, chemical, vibrational, or gravity-based agitation. Agitation herein is accomplished through the use of hydrodynamic pressures within the pod body of pod 110, namely hydrodynamic energy (liquid-based kinetic energy). Moreover, another embodiment describes the use of expandable-volume pods, subject to the hydrodynamic mixing process, instead of using mechanical agitation (like a conventional blender) or other agitation mechanisms as noted above to mix beverage materials with pressurized liquid within the fixed-volume pod body 111 of pod 110, which could in select embodiments be washed and reused.

Referring now to FIGS. 11-23 the example pod 110 includes a container or pod body 111, top end 112, bottom end 114, and a flange 104 containing a central opening 113 therein through which pressurized water and air may be introduced within. Although these features shall be explained in further detail hereafter, pod 110 is configured to receive entry of a pressurized liquid 105 (see FIG. 22) via central opening 113 into and through an internal hollow water vein element 116 attached to flange 104 at top end 112 of pod 110.

FIGS. 22 and 23 are provided to illustrate the uniform radial distribution of the water jets 106 exiting radial holes 117 and downward facing holes 119 during a mixing process within the interior of the pod body 111, so as to facilitate understating (in general) of the example method and system 100 for making the prepared beverage through hydrodynamic mixing of the beverage material 199 with the pressurized liquid (water-air mix) 105 introduced into the pod body 111 of the pod 110 from system 100. Namely, the water vein element 116 is adapted to receive the pressurized liquid 105 used for the hydrodynamic mixing through the pod 110's central opening 113 (which is sealed to the ring seal 136 within mixing chamber 130, as shown previously). Flange 104 at the top end 112 of pod 110, as shown between an upper end or rim of the pod body 111 and the bottom of the ring seal 136 is also scaled to the pod body 111 rim, creating a water-tight container for direct fluid flow inside the pod 110. Upon user actuation at control panel 140 to energize pumps 185 and 180 to start the mixing process, the pressurized liquid 105 flows into the hollow interior of the water vein element 116 and then exits the radial holes 117 and bottom facing holes 119 of the water vein element into the interior space of the body as an array of water jets 106. These water jets 106 create the hydrodynamic-based kinetic energy to impart turbulent flow within the interior space of the pod body 111 so as to rapidly saturate the beverage material 199 with the pressurized liquid 105 and form the prepared beverage, before any formation of a boundary layer which would create clumps of dry beverage material 199 in the beverage material 199/liquid 105 slurry which drains out of the exit hole 115 as the prepared beverage into a cup arranged beneath the pod in the cup receptacle area 150.

As will be described in more detail below, complete mixing of the beverage material 199 with the array of water jets 106 is a function of one or more of (a) spacing between the radial holes 117 and downward facing holes 119 in the water vein element 116, (b) size diameter of the holes 117/119, (c) water jet 106 velocity out each hole 117/119, and (d) overall liquid fluid flow rate of the pressurized liquid 105 exiting the water vein element 116.

As per FIG. 22, the array of water jets 106 include several water jets 106 shooting radially outward at multiple locations along the sides of the water vein element 116, several water jets 106 shooting at an angle downward relative to a horizontal plane through the water vein element 116 sides toward the pod bottom end 114, and multiple water jets shooting directly downward towards the exit hole at the bottom end of the pod.

As previously discussed in the background, >1% insoluble material clumps can often form in large pockets as the result of the creation of boundary layers, or in other words (and as shown in FIG. 2) layers of saturated powder (see region ‘A’) obscuring the liquid solvent from large areas of non-saturated powder (see region ‘B’). Thus, Applicant's design for its pod 110 and beverage forming system 100 is unique in part due to an intended purpose of mixing particle solutes having >1% insolubility, which bring challenges to proper wetting, saturation, and which are more prone to clumping than similar dissolvable beverage powders.

The clumps that may form when mixing >1% insoluble powders do not affect the efficacy or quality of the final prepared beverage product or its powder solute constitute (e.g., protein powder). But the presence of clumps may deter consumers from enjoying their beverage to the point that they will not regularly use the beverage mix product. Additionally, the process of manually mixing powdered solutes with a liquid solvent by shaking can by physically demanding, and it can be difficult to discern whether all the clumps are gone when looking through a protein drink (for instance), since it is often a non-transparent suspended solution.

The clumping issue can be compounded when an >1% insoluble solute concentrate is contained completely within a sealed cartridge or pod for use in conventional or known beverage forming systems, since the cartridge or pod has a finite space for mixing, and the conventional beverage forming systems have a constrained amount of time to complete the mixing process. Insoluble beverage materials commonly contain hydrophobic particles which repel water and water-based solvents, unlike other dissolvable beverage powder pods that are currently available in the marketplace.

As such, composition of powders containing over 2.0 grams of protein (or 20% by macronutrient-weight), otherwise known as “protein powders” are most prone to “clumping” within the cartridge or pod during the mixing process. This is mainly due to the presence of amino acids in the protein powder which can begin denaturing (causing modification of the molecular structure of the protein). The amino acids thus aggregate and agglomerate upon the introduction of water to the protein powder, due to the inevitable changes in environmental pressure as the beverage material is submerged under water pressure.

Since protein powders are among the most difficult of the >1% insoluble beverage materials to achieve complete mixing in a liquid, due to the presence of these amino acids, and as protein powders are commonly used by many adults to supplement a healthy diet, this became a focus in Applicant's original '907 application. Having solved the most difficult design challenge, the present disclosure is offered to provide a complete understanding of, and expand the claim scope of, certain mechanisms that control and drive the success of mixing >1% insoluble beverages under a given set of parameters. Namely, the example embodiments described hereafter not only are applicable to complete mixing of a beverage material 199 such as “protein powders” with pressurized liquid 105 to realize a prepared beverage, but are applicable to realizing complete mixing of any prepared beverage with liquid and powder solutes that possess >1% insoluble beverage material therein.

It should be understood that a >1% insoluble beverage material may have a range of properties other than simply containing proteins/amino acids, which can predispose such a beverage material to naturally attract/repel or easily absorb a greater volume of water prior to reaching its fully-wetted saturation point. Hydrophobic particles act differently in water than other powdered substances, such as mixability properties seen in dissolvable powdered sugar drinks such as KOOLAID®. Even where anti-clumping/anti-caking additives, super disintegrates, or other emulsifiers like lecithin or silicon dioxide are used, it can still be difficult to produce a smooth final prepared beverage consistency acceptable to the consumer. This is especially true when mixing a protein beverage from a protein powder concentrate without using mechanical agitation (motion energy) to physically break-up the clumps that often form when mixing a protein beverage. Hence the use of a hydrodynamic mixing process for mixing a >1% insoluble beverage material with a solute such as pressurized liquid to realize a smooth final prepared beverage with a consistency acceptable to the consumer is described herein.

Referring again to FIGS. 11-23, as previously noted the exit hole 115 is located at the bottom end 114 of pod 110 within pod body 111. Exit hole 115 is pre-formed in the pod body 111 in this embodiment; in another expandable embodiment described hereafter it may be formed by puncture of a spike 118 arranged on a distal tip of water vein element 116. In the present embodiment, exit hole 115 is drained or otherwise vented under pressure so as to release the final prepared beverage contents (“prepared beverage”) there through into a cup placed within the cup receptacle area 150.

When mixing >1% insoluble beverages using high pressure, the bottom end 114 of the pod 110 at exit hole 115 must be able to release and allow dispensing the prepared beverage so that the internal pressure within the pod body 111 during the mixing process does not come to pressure-equilibrium with the water pump 185. Under pressure equilibrium, fluid flow of the pressurized water would terminate, usually resulting in an improperly or incompletely mixed prepared beverage. Hence, the use of high pressure mixing herein is a benefit for preventing the exit hole 115 from clogging, a problem inherent in conventional low-pressure brewing systems. Further, an additional responsibility is to ensure that clogs really don't happen within the pod body 111, since the back-pressure “blowout” effects often seen in clogged low-pressure brewing systems would be more dramatic in system 100 (due to the higher-pressure of system 100) were exit hole 115 to clog in a similar way.

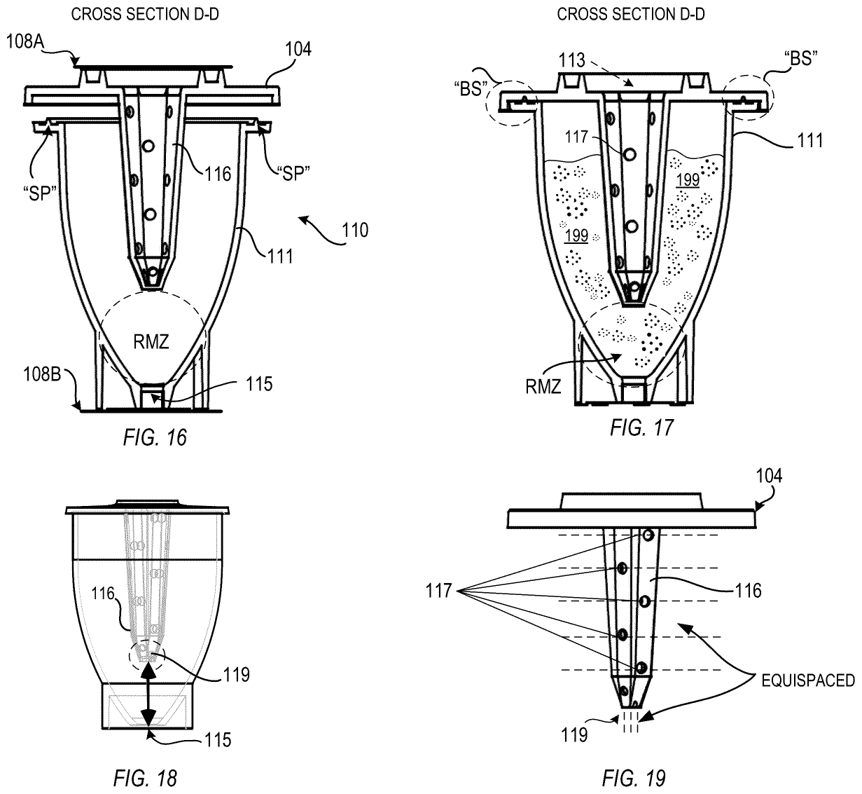

Thus, the formation process for the exit hole 115 is not as critical as the resulting form factor of the exit hole 115 and its functional impact on mixing, namely the diameter of the exit hole 115. As previously described in Applicant's '907 application, the region inside the pod body 111 which is directly above the exit hole 115 and directly below the downward facing radial holes 119 is a “rapid-mixing zone” (see FIGS. 16, 17 and/or 22, or “RMZ”) with converging turbulent flows all funneling down towards the exit hole 115.

For example, if the exit hole 115 was to be increased to be 2-3× larger in diameter, the volume of prepared beverage exiting pod 110 per-second would increase dramatically. The result of this larger exit hole 115 diameter would be the loss of the necessary back-pressure to create the aforementioned rapid mixing zone (RMZ), due to turbulent flows being allowed to exit the pod 110 through larger diameter exit hole 115 in a more directly-downward manner, instead of being forced to converge around the contours of the water vein element 116 and interior walls of the pod body 111 to fit through a smaller diameter exit hole 115 (see at FIGS. 19, 20, 22, 23).

A loss of sufficient back-pressure would lead to premature exiting of the beverage material 199 (shown generally in both FIGS. 17 and 22 within pod body 111) prior to its proper saturation and mixing by the pressurized liquid 105 solvent (water-air mix) provided by water pump 185 and air pump 180 into water vein element 116. Therefore, the relative diameter of the exit hole 115 is a necessary consideration when using hydrodynamic energy-based agitation within the pod body 111 for mixing, as opposed to mechanical agitation (motion energy), heat (thermal energy), or any of chemical, vibrational, or gravity-based agitation.

Proper use of the back-pressure caused by the exit hole 115 forces the saturation of the beverage material into a slurry-like solution which can then be transferred downward to the rapid mixing zone (RMZ) and prevent excess residue backing up on the interior walls of the pod body 111. In the example, system 100 will rapidly mix the beverage material 199 with the pressurized liquid 105 (a solvent such as a liquid, water, air-water mix, etc.) and saturate the solute beverage material 199 (such as a protein powder) into a uniformly mixed liquid solution (or suspended-solution, for >1% insoluble beverage materials 199) that is dispensed as the final prepared beverage draining/venting under pressure into the user's cup below within cup receptacle area 150. As demonstrated by tests run by Applicant, an insufficiently large exit hole 115 diameter will quickly and readily result in clogged draining, especially with the use of >1% insoluble beverage material ingredients.

Once the mixing process is initiated via user actuation of the control button at control panel 140, the mixing process will automatically terminate at a certain time interval after initiation. This time internal is dependent on certain system parameters for a desired volume of liquid. A typical beverage varies from about 4 to 20 fluid ounces in size, with the most common sizes in the 8 to 16 fluid ounce range.

According the example embodiments and based on testing performed by Applicant, a pressurized liquid pump (water pump 185) connected to a liquid source dispenses about 6 to 12 oz. of fluid to sufficiently wash away the protein powder contents and complete mixing of the prepared beverage. The relative dispensing-time through the exit hole 115 (at a selected hole diameter) which creates sufficient back-pressure for uniform saturation of the beverage material 199 inside the pod body 111 thus may vary as a function of the exit hole 115 diameter, and the run time and cadence of both the water pump 185 and the air pump 180.

Namely, at the end of the mixing cycle the air pump 180 is employed to perform a draining cycle without additional water to limit the ratio of liquid-dilution for the final prepared beverage. The process of initiating draining separately from mixing is a departure from other conventional beverage forming systems. The volume of pressurized liquid 105 used creates the sustained and total amount of hydrodynamic energy put into the system, and therefore the total energy-input is directly correlated to the volume of solvent used. In other words, the energy input from the system 100 to the pod 110 will dictate the total volume of pressurized liquid 105 (such as water) used during the mixing process, unlike traditional mechanical agitation systems like a blender which can continue to add energy to the prepared beverage mixture without altering the total volume of fluid used.

Additionally, the type of water pump 185 will also dictate performance, with some water pumps being designed as more-resistant to back-pressure in the output mechanism (e.g., positive-displacement pumps) than other pumps (e.g., centrifugal pumps). Certain water pumps may be chosen for particular performance characteristics, such as the ability to push-through clogs that cause back-pressure (e.g., positive displacement pumps) or the ability to curtail the amount of pressure provided to the pod 110 in order to prevent excessively strong output water streams (e.g., centrifugal pumps).

Applicant has noted that the volume of liquid solvent used (pressurized water or liquid 105) is chosen so as to not unnecessarily dilute the beverage material 199, but which is enough of a volume to achieve desired saturation performance, necessary energy input for complete mixing and to avoid boundary layer formation. Additionally, Applicant has determined the air pump 180 run time needed for porting the air into the pod body 111 in order to successfully dispense and mix the beverage material 199 with the pressurized water. Thus, a typical cup filling time (mixing cycle time) may be between 2 and 60 seconds long, with a typical average prepared beverage mixing cycle time being in the range of about 3 to 20 seconds. With the understanding that mixing cycle time varies depending on the pod design (the single-serving pod 110 or a single-serving expanded pod 110′ described hereafter), air pump 180 and water pump 185 runtimes are to be catered for the specific beverage preparation application, and adjusted for performance and cycle cadence relative to each other.

In an example, as Applicant addressed in their '907 application, initial wetting and saturation of the beverage material 199 is successfully achieved where the water pump 185 starts momentarily before the air pump 180, and both pumps 180, 185 run concurrently until the proper-serving of liquid solvent out of reservoir 120 has been pressurized and dispensed into the water vein element 116 within pod body 111, at which time the water pump 185 shuts off and the air pump 180 continues alone until the draining process of the prepared beverage through the exit hole 115 into the cup below is complete. By cycling the pumps at the desired intensity levels while using an optimized operating-cadence of triggering the pumps 180 and 185, the interior volume in pod body 111 reaches appropriate water pressure levels that produce optimal conditions for turbulent flow and therefore the excessive generation of free hydrodynamic energy for the solute/solvent to absorb rapidly as the mixture seeks to reach a higher entropy state, like all particle groupings reach over time according to the second law of thermodynamics.

Accordingly, bringing the interior volume of the pod body 111 to a sufficiently high internal pressure using the pressurized liquid 105 from the water pump 185 (with the mixed in air from air pump 180), enables the pressure within the interior of pod body 111 to “force saturate” nearly all of the beverage material 199 (such as protein powder) in a matter of seconds. The rapid speed of saturation prevents the creation of the aforementioned boundary layers. The time at which the beverage material 199 has become fully saturated inside the pod body 111 (where it is in a semi-solution, thick slurry type state) but has not been dispensed through exit hole 115, signifies the point where it is most prone to dissolve completely with the least amount of further agitation/energy required.

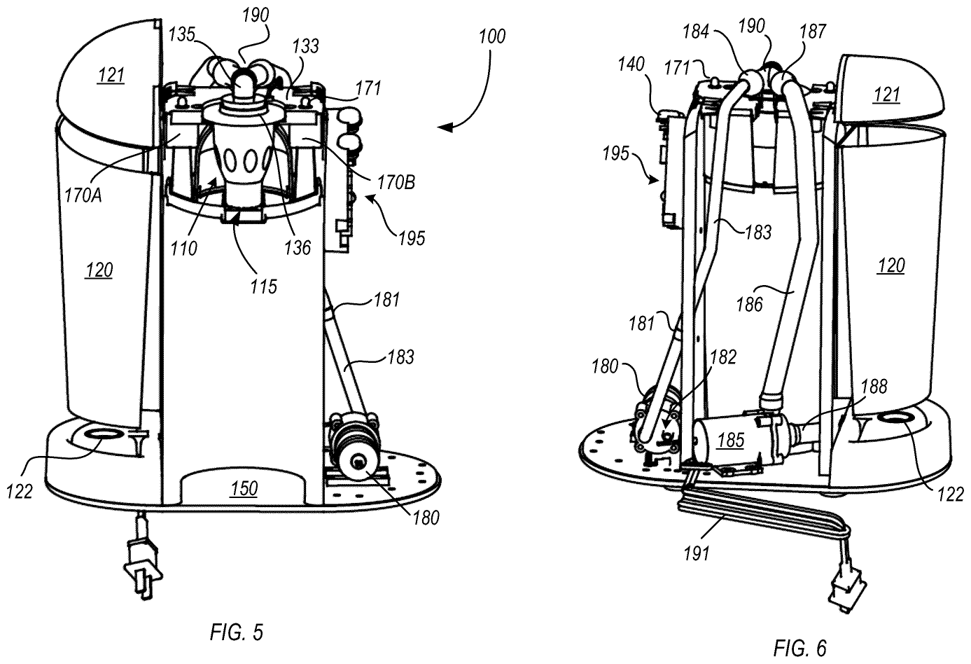

Referring to FIGS. 5-8 and 10, another factor in desired system 100 performance is the minimization of the amount of air trapped in the elbow-shaped inlet line 189 downstream of the Y-connector 190 connected to both the water check valve 187 and air check valve 184. Limiting air in inlet line 189 is necessary because any entrapped air would be the first fluid (gas) that gets pumped through central opening 113 into the pod body 111 of pod 110 at the beginning of a mixing cycle. Even if the water pump 185 is started by itself to begin the mixing cycle without the air pump 180, any air trapped inside inlet line 189 is still downstream of the water check valve 187 and therefore ahead in-line of the incoming pressurized water flow. As such, the air will enter the pod 110 ahead of any liquid solvent.

As Applicant has observed during testing, with any substantial amount of entrapped air entering the pod body 111 initially, the beverage material 199 could be successfully fully-dispensed from the pod 110 in a completely dry-state, and will then not be fully-mixed in the cup below the mixing chamber 130. This is because the presence of significant entrapped air volume can cause significant amounts of dry powder to dispense into the cup below, which is prone to the formation of a boundary layer within the dry beverage material 199 that has been dispensed without ever being saturated first inside pod 110 prior to exiting into the cup in the cup receptacle area 150. Initially dispensing too much dry beverage material 199 will cause boundary layers in the bottom of the cup, which acts to conceal a completely dry section of the beverage material 199 that has not mixed, remaining submerged deep in the remainder of the prepared beverage that drains or vents into the cup after it.

As is known and as was described in Applicant's '907 application, and as shown in FIG. 2 (within the pod, as opposed to the cup), such a boundary layer has a region of powder which remains completely dry even though it is fully immersed under water, and even after being sprayed by the rapid downward exiting prepared beverage through exit hole 115 into the cup, is an excellent demonstration why gravitational energy (low water pressure) techniques used in beverage forming systems simply cannot functionally work to effectively saturate a serving of an >1% insoluble beverage powder such as the protein powder.

The dispensing of some amount of non-saturated (dry) beverage material 199 at the beginning of the mixing cycle is inevitable to a small degree at the beginning of the mixing cycle, because there is a small amount of air that will always inevitably be trapped in the minimized volume required inside inlet line 189 and hollow water vein 116. Although Y-connector 190 and inlet line 189 could be a singular piece, these are shown as separate components in order to precisely identify the critical volume of space after the check valves (187/184) inside of the Y-connector 190 and inlet line 189 that are in-line prior to the central opening 113 at the top of the hollow water vein element 116; this space represents the volume of air first pumped into the pod 110 at the beginning of the mixing cycle

Reducing the volume of air trapped inside inlet line 189 (and Y-connector 190) will directly allow system 100 to reduce the amount of dry powder (beverage material 199) dispensed in the cup at the beginning of the mixing cycle. As addressed previously as a consideration, it is also helpful to start the water pump 185 momentarily before the air pump 180 to help the initial wetting and full-saturation of the beverage material 199 prior to it exiting the pod 110. Since rapid wetting and full-saturation of the beverage material 199 helps to prevent formation of boundary layers, the best practices described above include initially pumping in the pressurized liquid alone (with no air). This is done rapidly and at a high-volume in order to give the beverage material a chance to reach the force-saturation (or otherwise put, the full-saturation) point of the powder as uniformly and quickly as possible; this jump-starts the mixing process.

The rapid saturation minimizes the total amount of energy required to uniformly mix the beverage material 199 because rapid saturation helps to avoid the temporary negative-entropy swings seen in the form of clumping. Thus, since system 100 does not have to break-up any clumps, it takes less energy to complete the mixing process.

Conversely, conventional blended beverage systems for complete mixing are not concerned with the initial formation of boundary layers or the need for breaking up clumps. This is because these blended beverage systems (a) are designed so as to use an over-abundance of energy during the mixing process anyway, and (b) mechanical agitators in these blended beverage systems are capable of physically pulverizing clumped beverage materials down, so it is not a concern for them.

When there is too much air trapped inside of Y-connector 190 and inlet line 189, another failure mode which may be seen is that sometimes the exit hole 115 will get clogged. So reducing the amount of standing air trapped in the tubing of Y-connector 190 and inlet line 189 (both of which are downstream of the check valves 184, 187) is necessary, as too much air in the system tubing will cause a large amount of beverage material 199 (such as dry protein powder) to be the first thing to be dispensed into the cup receptacle area 150, and the remaining powder will not saturate properly since it does not have the required back-pressure. This is the reason that the water check valve 187 is directly attached to Y-connector 190, and not further upstream of Y-connector 190, separated by a length of tubing.

Small amounts of dry beverage material 199 that will inevitably be dispensed into the bottom of a glass or cup due to the unavoidable minimized air pocket volume trapped in the inlet line 189 will mix in-the-glass when the pressurized liquid stream of final prepared beverage directly follows these small amounts of dry beverage material 199 into the glass, provided that the air entrapped in inlet line 189 has been properly minimized. This, along with properly configured system parameters such as pump cadence and run time (addressed hereafter) eliminate boundary layer formation.

Minimizing the air trapped in the water-vein element 116 is also required, thus a design which permits an excessively large air pocket to form inside the hollow water vein element 116 would exhibit the same issues as above. Accordingly, entrapped air in the system in-line tubing downstream of the water check valve 187 (and upstream of central opening 113) must be limited to a minimum for this additional reason. Otherwise, accumulation of powder in the cup or glass may reach a level which would produce clumps in the cup below, even with the pressurized prepared beverage dispensed out of exit hole 115 and landing directly on top of the dry powder/clumps in the cup.

As noted above, the food-grade air filter 181 purifies the air of particulates prior to passing through air check valve 184 and introducing it to the water for mixing it at the base of Y-connector 190. The air check valve 184 releases air into the Y-connector 190 which merges the pressurized air and pressurized water from water check valve 187 and carries the pressurized water/air mixture (pressurized fluid 105) to the inlet line 189. The inlet line 189 ports the pressurized fluid 105 out the fluid exit nozzle 135 into a pod 110 entry point, represented in various figures as the aforementioned central opening 113 at the upper or top end 112 of the pod 110. Once the mixing chamber 130 is closed onto the pod 110 by the raising of DC solenoids 170A and 170B (see FIGS. 5 and 7), through a connection established by the ring seal 136, the distal end of the water pump exit line 186 is associated to or otherwise connected to an upper end of a water vein element 116 at the central opening 113 in pod 110. The DC components pictured (solenoids 170A and 170B) are representative of any well-known DC components which are capable of articulating in a linear motion (e.g. linear actuators) that can be interchanged to achieve the desired lifting/closing effect to seal the pod 110.

Additional air is pumped (also through the food-grade air filter 181) from the air pump 180 during the mixing process to further assist in the beverage mixing process in multiple ways. Beginning with the most trivial, once the perquisite amount of water has been pumped into the pod 110 during the mixing cycle, the air pump 180 can be used to assist with hastening the draining or venting process of the prepared beverage out exit hole 115 and into a cup or glass resting in the cup receptacle area 150. The use of air instead of additional pressurized water (solvent) is functionally beneficial because it helps avoid unnecessarily diluting (or “watering down”) the flavor profile of the prepared beverage. After the water pump 185 has run its full cycle, it stops near the end of the mixing period based on the desired pressurized liquid 105 volume to be used, and then air only is pumped (via Y-connector 190, inlet line 189, and exit nozzle 135) into the pod 110 to complete the draining process of the prepared beverage, which runs until the pod 110 has drained fully and no longer has any liquid contents remaining therein.

A less trivial way that the air pump 180 impacts the mixing process is that air pumped into the pod body 111 during the mixing cycle rises to the top of the interior of the pod body 111 during the mixing cycle, which in turn forces the final prepared beverage (the mixed slurry/mixture) downward within the pod body 111 (via gravity, liquid being heavier relative to the newly-added air) towards the exit hole 115, where the turbulent flow created by the pattern of water jets 106 emitted from the radial holes 117 and downward facing holes 119 in water vein element 116 produce a region of incredibly intense energy transfer (the aforementioned rapid mixing zone) directly above the exit hole 115 and below the downward facing holes 119 (see any of FIGS. 16, 17, 22).

Referring now to FIG. 22, once the downward facing water jets 106 exiting the downward facing holes 119 remove remaining beverage material 199 located in the RMZ directly over the exit hole 115, which opens the venting or draining path for the rest of the beverage material 199/pressurized water 105 mixed slurry during mixing, then the upper layers of powder (beverage material 199) begin to get pulled down by a syphoning effect and collapse down into the bottom interior region of the pod body 111 (again into the RMZ). It is within the RMZ that the most turbulent water jets 106 (from downward holes 119 and the lowest row of downwardly angled radial holes 117) are spraying into a tightly confined/converging-diameter space. The RMZ thus creates the most turbulence due to hydrodynamic flow principals (such as Bernoulli's Principle). Accordingly, the RMZ with this most vigorous mixing has the greatest amount of excess energy to freely transfer over into the chemical bonds of the solute/solvent mixture (i.e., the prepared beverage).

Much like other parameters of system 100, the volume of air pumped into the pod 110 needs to be catered to the specific type of beverage material 199 and the form factor of the pod body 111. Otherwise, should too much air be pumped into the pod 110, the powdered beverage material 199 ingredients inside may begin to float atop the pressurized liquid solvent. This happens because there is too much empty space within the pod body 111 created by the air, such that the beverage material 199 will not become saturated quickly enough, ultimately leading to potential failures during mixing.

Air pump 180 insertion of air into the water during the mixing process provides another non-trivial benefit to the mixing process. Any air bubbles pumped past the air check valve 184 and mixed into the liquid solvent in Y-connector 190 are then transferred via inlet line 189 into the hollow water vein element 116 through central opening 113. These air bubbles are subjected to a variety of pressure and form factor changes as they eventually sift their way to the upper region within the pod body 111 interior.

During this process, the contorting of air bubbles through small openings like the radial holes 117 can cause the air bubbles to cavitate inside the fluid. The process where a void or bubble is subjected to a high pressure in a liquid and rapidly collapses to produce a shock wave is known as inertial cavitation. These shock waves are strong when they are very close to the imploded bubble, but rapidly weaken as they propagate away from the implosion. This is the reason that the pod body 111 will not crack due to these bubble cavitation effects (implosions) during mixing, the low level of propagated force prevents it from doing so, despite the inertial cavitation of air bubbles within it.

With reference again to FIGS. 11-23, and in one example, pod 110 is intended to be single-use to prevent the potential for bio-contamination caused by improperly cleaned reusable containers. This is especially true for nutritional powders such as protein powder, because a protein powder has a tendency to clump, stick to walls, and otherwise leave a bio-film type residue which a user must physically scrub off. Protein is an amazing building-block for the human body, but as such, it is also excellent for fueling the rapid growth of bacteria.

The single-serving pod 110 design of this beverage forming system 100 is a breakaway solution as compared to other conventional options for mixing protein powders because Applicant's solution requires zero clean-up aside from discarding the empty pod 110 after complete mixing of >1% insoluble beverage materials. All this is accomplished without any mechanical agitation (motion energy) or heat (thermal energy).

In another example, pod 110 may be made of a material such as PP, HDPE or LDPE recyclable plastic and may thus be immediately recyclable after preparation of the mixed beverage since there is such minimal residue left in the empty pod after the beverage/drink has been made. In these examples, the components of the top end 112 and bottom end 114 of the pod 110 may be formed of the same recyclable materials, realizing an assembly of homogenous material. This is unlike those K-CUP pods not intended for filtered brewing, which have a plastic base and an aluminum foil lid that must be separated to be properly recycled (since they are made of different materials). Moreover, if the K-CUP pod is in fact designed for a filtered brewing process, the interior filtering element and leftover solid beverage waste-materials must also be physically removed and discarded prior to recycling the two separate materials of the top and bottom of the K-CUP pod.

Low-pressure beverage forming systems like KEURIG thus utilize a thin/flimsy aluminum-foil cover on the top of their pod or cartridge, since the connection point to the water source is provided at a drip-brew pressure, or in other words at such a low pressure that errant flows exhibited due to pressurized liquid streams are not at issue. System 100 dispenses the prepared beverage directly from the pod body 111 via the exit hole 115 into the cup receptacle area 150 without touching any part of system 100 itself. Since sugar, protein, and other foodstuff-based ingredients are an ideal building-block for bacterial growth, if the system 100 does become dirty over time from the residue left by any errant liquid streams exiting the pod 110, users will quickly identify the foul smell which leftover residue produces when left to sit out continually.

In one example, pod 110 is made entirely from the same recyclable plastic (once hermetic seals 108A and 108B are removed), and since the pod 110 washes out completely and cleanly after mixing cycle completion, pod 110 is ready for recycling without preparation. This is yet another functional aspect absent in any other cartridge-based beverage product usable in conventional beverage forming systems. Even coffee pods made completely of aluminum material offered by such brands as NESPRESSO® still contain a filtered solid waste product (the used coffee grounds inside) that must be removed prior to the cartridge being recycle recycle-ready.

In yet another example, some or all of the pod 110 may be composed of thin food-safe vacuum formable, blow-moldable, or injection molded plastic(s). In this example, the top half of the pod 112, inclusive of flange 104 with attached water vein element 116 may be a singular piece via injection molded plastic materials and the like. The plastic may be malleable so that the entire pod 110 is capable of plastically deforming and rebounding by a small amount, but the water vein element 116 remains sufficiently stiff to hold up during transport prior to use.

Within the mixing chamber 130, the central opening 113 of pod 110 remains sealed to the ring seal 136 throughout the entire mixing process in such a way that every part within the interior volume of pod body 111 is completely air-tight in every place but at the exit hole 115. Flange 104 on the pod 110 is used to alignment to guide pod 110 into the correct position when being placed into the pod holder 133. As shown in FIGS. 11 and 16, a set of easily removable upper and lower hermetic seals 108A and 108B are provided. These hermetic seals 108A, 108B may be composed of a thin aluminum foil, plastic, wax or paper, and are configured to protect and maintain the exit hole 115 and central opening 113 covered so as to keep the water vein element 116 protected and food-safe during storage and distribution.

Before describing the mixing operation in more detail, an overview of the basis for Applicant's definition of “mixing” is described. Near complete dissolution (the part soluble) and/or dispersion (for any part insoluble) of the beverage material 199 (such as protein powder) within the pod body 111 of pod 110 is achieved by using the water pump 185 and air pump 180. These pumps 185, 180 create pressure and turbulence inside the pod 110, via the formation of a plurality of water jets 106 exiting the water vein element 116 through a plurality of radial holes 117, effecting the mixing process to mix the pressurized liquid with the beverage material 199 within pod body 111. The final mixed or prepared beverage thus drains through the exit hole 115 into the cup receptacle area 150 below the mixing chamber 130.

An example of a successful mixing process is where substantially all (95% or more) of the beverage material 199 is removed or exits the pod body 111 through exit hole 115 during the mixing cycle, with the exception of very minor residue. Such minor residue may remain after a mixing process for more-viscous and more-concentrated volumetric mixtures and those with >1% insoluble beverage material ingredients. In recalling how large clumps can occur due to creation of boundary layers (i.e., layers of saturated-powder concealing regions of non-saturated powder), the formation of any boundary layers would represent a failed mixing process. In such a case, the beverage material would not become fully-saturated, full-dispensed, or fully-mixed. This ultimately would result in a partially/incompletely mixed prepared beverage, potentially leaving behind fully dry regions of beverage material beneath any boundary layers still inside the pod body 111 (see again FIG. 2) or in cup receiving the final prepared beverage therein. Clumping issues and boundary layers may further possibly even clog the exit hole 115 of the pod 110 if the system 100 output pressure is not high enough to overcome the above-noted back-pressure issue caused by the clog, which effectively stops complete mixing.

Saturated clumps which are large enough to see but small enough to pass through the exit hole 115 may also possibly be dispensed into a consumer's glass or cup. If these clumps are over 2.5 mm in diameter, they likely will be noticeable to the consumer while drinking the final prepared beverage. Such clumps would be indicative of insufficient or improper mixing of the final prepared beverage.

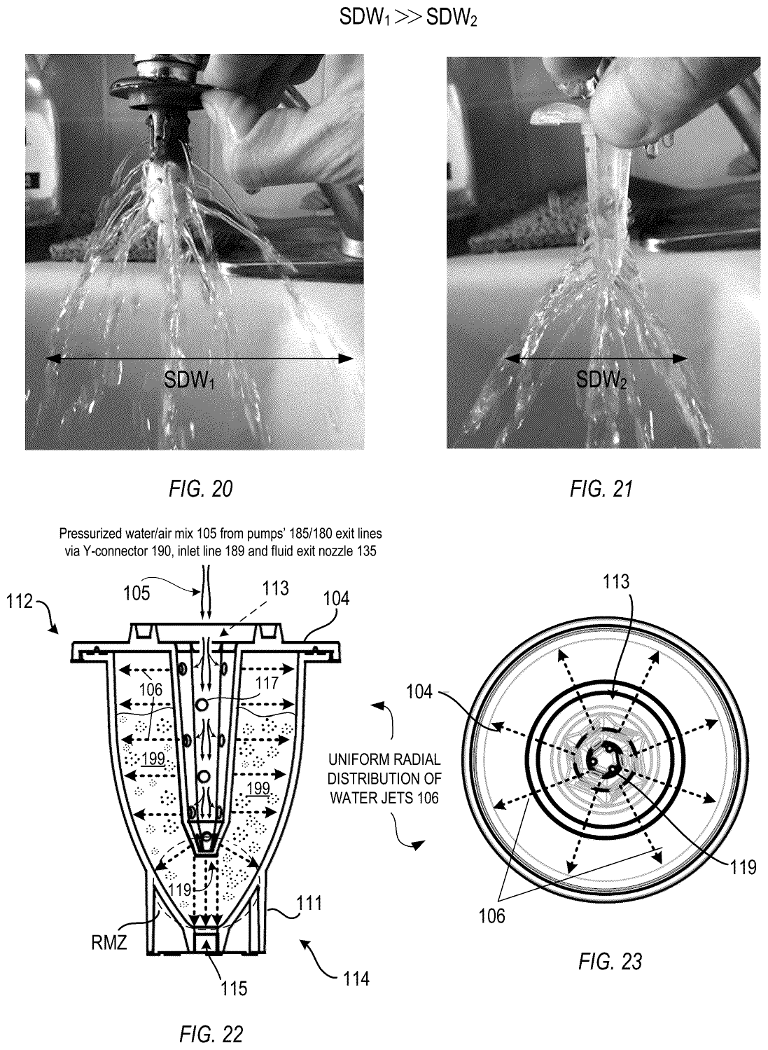

However, and although there may be slight residue remaining inside the pod body 111 after draining of or venting of the prepared beverage out exit hole 115 into a cup, the turbulent flow provided by the pattern of water jets 106 within the interior of pod body 111 facilities near-complete mixing, whereby almost all of contents therein are washed out completely upon completion of draining or venting. FIG. 20 is a photo demonstrating good water flow distribution of the water jets 106 up the majority of the length of the water vein element 116 without applied back-pressure, consistent with the example embodiments. FIG. 21 is a photo showing poor water flow distribution of the water jets 106 up the majority of the length of the hollow water vein element 116 without applied back-pressure

When mixing beverage material 199 ingredients having >1% insoluble content with the pressurized liquid, the pattern of fluid spray exiting through exit hole 115 may become more errant in nature, due to a greater number of differences in viscosity within the consistency of the suspended solution mixture. In order to prevent errant spray, one strategy is to maintain the top of the cup or glass as close to the exit hole 115 as possible. In this case, a removable cup tray (not shown) may be provided in cup receptacle area 150; it may be removed and used to elevate the cup closer to the exit hole 115, and also used to easily clean the base of the cup receptacle area 150. Further, such a removable tray may allow for a slightly taller cup, glass or mug to fit in the cup receptacle area 150 below the mixing chamber 130.

Accordingly, the form factors of the pod 110 shown in FIGS. 11 to 18 and 21 to 23, in combination with proper system 100 runtime parameters, is designed so as to promote successful mixing for difficult-to-mix >1% insoluble beverage materials (partly-immiscible liquids and partly-insoluble powdered solids) as described herein. While the example embodiments pictured herein show the beverage material 199 as a protein powder drink substance (or “beverage mix”) packaged into a pod 110, the interior dry contents of pod 110 could alternatively include any of sugared powdered drinks, kids' drinks, energy powders, melatonin (and other sleep-aid) powders, plant-based shakes and foodstuff beverages, pre-workout and post-workout formulas, other nutritional supplements, and vitamin substances, etc.

The mixing time periods and form-factor of the pod body 111 may vary depending on the type and composition of beverage material 199 within the interior of pod body 111. This is because the composition of some beverage materials may have particles that may be easier to mix or dissolve, or where some powders may be more hydrophobic than others, thus potentially requiring more or less wetting-time (minimum time to saturation) and custom parameters during mixing to achieve proper saturation and properly mix the beverage and allow it to vent via exit hole 115. Applicant anticipates cup fill times being in a range between 5 and 20 seconds before the draining process is completed, with longer mixing cycle times being correlated to beverage materials that are have higher levels of insolubility and are therefore more resistant to effortless mixing/dispersion.

FIG. 22 is front plan view of the example single serving pod 110 to show equal thickness positioning of interior wall distance to points along the water vein element 116 sides across interior middle and lower portions of the pod body 111, and FIG. 23 is a top plan view of the pod 110 to show equal radial positioning of the radial holes 117 in the water vein element 116 across an interior upper portion of the pod body 111. Another factor to ensure more complete or uniform saturation of the beverage material 199 within the pod body 111 is the radial-distance between the sides (along the water vein element 116) and the inner sidewalls of the pod body 111. This is shown by arrows within the pod body 111 in FIGS. 22 and 23.

As such, setting the distance between the radial holes 117 along the sides of water vein element 116 (FIGS. 19, 22, 23), as well as the distance between the downward facing holes 119 at the bottom of water vein element 116 and the exit hole 115 (FIG. 18) so as to be equispaced is another consideration to promote complete mixing. The plurality of radial holes 117 are arranged in equal spaced relation to one another along the sides of water vein element 116 and are each equidistant from the inner surfaces of pod body 111 so that, once a mixing process has been initiated and the sealed central opening 113 is connected to the fluid exit nozzle 135, the pattern of water jets 106 is created due to pressurized water from the water pump 185 (and air pump 180) entering the hollow water vein element 116. As has been discussed, this creates turbulent flow within the closed interior space of pod body 111 to promote mixing of the pressurized liquid with the beverage material 199 therein. Air will also begin to accumulate within the upper interior region of pod body 111, slowly forcing the mixed solution downward through exit hole 115 into the cup receptacle area 150 that is positioned directly below the mixing chamber 130.

Generally, uniform radial thickness within the interior mixing region of pod body 111 is an effective technique to encourage proper mixing of >1% insoluble beverage solute materials using only pressurized water jets (hydrodynamic energy). If the initial distribution of pressurized liquid 105 is not done correctly, boundary layers such as shown in FIG. 2 would form at the bottom end 114 of the pod 110 within pod body 111, or at the top of the pod interior if the beverage material 199 “bottoms-out” through the exit hole 115 too soon and insufficient back-pressure is created for complete mixing. As the incoming liquid solvent would follow the path of least resistance to the exit hole 115, exit hole 115 could become clogged during such draining and dispensing of the prepared beverage as a result. Hence, prevention of boundary layer formation and the attainment of uniform saturation is possible as a function of one or more of the size, spacing and relative pattern array of the plurality of holes (117 and 119) in water vein element 116, which results in fully-dispensing and fully-mixing the beverage material 199 within pod body 111.

The patterned distribution of radial holes 117 and downward facing holes 119 across, around, and along the entire water vein element 116, and the proper sizing of holes 117 and 119 enable a uniform water jet distribution stream (as shown in FIG. 20). One skilled in the art could find many shapes, patterns, and size of radial holes 117 and downward facing holes 119 that could work, but the photos shown in FIGS. 20 and 21 demonstrate that a successful distribution of properly-sized holes is non-trivial at modest water pressures. Namely, FIGS. 20 and 21 offer a typical demonstration of the co-dependent effects of water-jet-hole size, height between rows of water jets-(equispaced, see FIG. 19), water jet velocity out each hole (which varies depending on the row of holes in the sides of water vein element, as seen in FIGS. 20 and 21), overall liquid fluid flow rate, and even microscopic factors such as surface-tension occurring at all the various smaller water-jet exit points.

Some of these radial holes 117 may be directed radially out from the side of the water vein element 116, so as to port straight outward, (or even downward pointing) such as the angularly profiled holes 117 in the lowest row of water vein element 116. This arrangement of radial holes 117 is thus a combination of radially direct side holes 117, angularly profiled holes 117 on a rounded surface that form angled water jets 106, and/or downward water jets 106 created through the downward facing holes 119, which generate turbulent flow near the exit hole 115 so as to agitate the prepared beverage additionally upon exiting the pod body 111. This further deters clumping and prevents clogging near the exit hole 115.

Thus, water jets 106 formed by porting pressurized liquid 105 through the radial holes 117 shoot directly straight out, with the exception of certain radial holes 117 formed on angled/curved surfaces as the bottom row along the sides of the water vein element 116 (shooting diagonally downward at an angle to the horizontal, as shown in FIG. 22).

The downward facing holes 119, which create downward water jets 106 that create the rapid mixing zone (RMZ) as noted previously, work together with the pressure created by the pressurized water 105 exiting radial holes 117 along sides of water vein element 116. The result is water jets 106 shooting directly outward from the sides to the inner surfaces of pod body 111, and water jets 106 shooting out at an angle relative to horizontal due to being located at the bottom angled or curved portions of water vein element 116 (bottom row of holes in the water vein element 116 of FIG. 19). These downward water jets 106 provide necessary additional agitation for mixing with and saturating beverage material 199 within the pod body 111 residing towards the bottom end 114 of pod 110, facilitating complete mixing of the final prepared beverage that drains/vents out exit hole 115.

Accordingly, the arrangement of radial holes 117 and downward facing holes 119 in water vein element 116 promotes near-complete mixing of all [liquid and powdered]>1% insoluble beverage materials 199 in water (pressurized liquid 105), much more so than if the water jets 106 from the downward facing holes 119 were absent. Without the downward facing jets 106 being pointed at exit hole 115, the creation of boundary layers and associated clumping and/or clogging within the interior space of pod body 111 directly below the water vein element 116 can easily and readily occur.

In addition to these downward-facing water jets 106 created by the downward facing holes 119 to promote effective draining and prevent clumping and clogging of powdered beverage materials 199, the angular water jets 106 exiting downward from the radial holes 117 towards the bottom inside corners of the pod body 111 are positioned at the first row just above the downward facing holes 119 (see FIG. 22, the bottom row of holes 117 in water vein element 116). This angular profile further helps eliminate problems in an expected area where clumping was commonly observed during tests due to an increased radial distance from the water vein element 116.

By making the internal radial distance between the water vein element 116 sidewalls to the inner surfaces of pod body 111 equal or relatively even, saturation of beverage material 199 (such as dry protein powder) thus occurs in a more uniform manner along the length of the water vein element 116 as the pressurized water 105 saturates the beverage material 199 evenly around all sides of the water vein element 116.

Additionally, the form factors of the water vein element 116 and that of the pod body 111 could take on many different shapes to facilitate equispacing between adjacent ones of radial holes 117 and adjacent ones of downward facing holes 119 (FIG. 19), as well as to facilitate equal radial distance between the sidewalls of the water vein element 116 and the inner walls of the pod body 111 along the length and profile of the water vein element (FIGS. 22 and 23). With considerations of large scale manufacturing and formability for plastic injection molding in tooling molds, the form factor of the pod body 111 and water vein element 116 according to the example embodiments are each designed with a naturally-tapered shape.

Further, there may be alternative form factor shapes that may possess the above characteristics (equispacing between adjacent ones of the radial holes 117 and ones of downward facing holes 119, equal radial distance between the holes 117/119 on sidewalls of the water vein element 116 to the inner walls of the pod body 111) for the uniform saturation of the beverage material 199 to occur. One example may be a “shower head” form factor for the plurality of radial holes 117 in water vein element 116. For this example, the corresponding shape for the pod body 111 might be a thin flat disk of relative uniform-thickness which is positioned adjacent to a companion hollow water vein “disk”.

Working Example. Applicant prepared a specific protein powder pod for use in their commercial beverage forming system. Protein powder is the most difficult insoluble beverage to mix, and is exemplary of a serving size for all >1% insoluble powdered beverage materials useable with Applicant's system.

Namely, system 100 received a single-serving pod 110 in its mixing chamber for operation. The pod 110 contained between 20 to 25 grams of total powdered beverage material for beverage powders having >1% insoluble content. In this particular working example, pod 110 contained 22 g of 80% dairy-based whey protein concentrate powder, 15 grams of which was total protein. Applicant notes that all powders have in common, at some level, a propensity to clump upon introduction to a liquid solvent source, even if the powder is later able to be fully-dissolvable.

Applicant's commercial system successfully and fully mixed this powdered beverage material with pressurized liquid (liquid solvent base) to realize the prepared beverage without clumps present due to formation of a boundary layer. Applicant's commercial system has also been shown to successfully mix other insoluble powders at the same concentrations inside the pod 110, such as plant-based protein, foodstuff beverages, whey isolate, and foodstuff “superfood blends” including pea, nut and seed-based protein powders and green vegetable powders, as well as any powdered beverage material which is dissolvable, or is prepared from a dehydrated liquid solution concentrate and thus fully dissolvable upon reconstitution into a solution by the liquid solvent base.

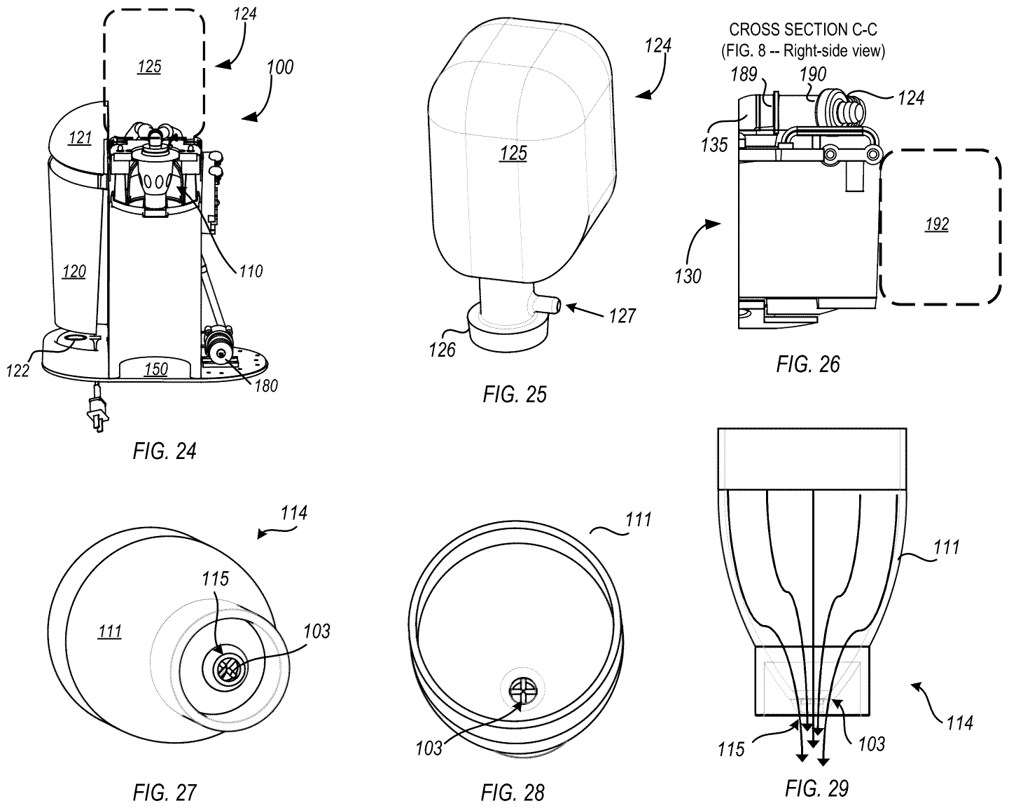

FIG. 24 is the front plan view of the beverage forming system 100 indicating a location for a removable secondary reservoir 124 for direct connection to pod 110 according to another example embodiment, and FIG. 25 is a rendering of the secondary reservoir 124 showing additional details for the containment of perishable liquids. The secondary reservoir 124 may include a hollow container 125 designed to hold or be filled with perishable liquids other than water (milk, juice, other). While many conventional beverage forming systems claim functionality using any “liquid source”, these conventional systems have not solved the design challenge of passing perishable liquids through transfer lines that subsequently must be cleaned sanitarily after each use. If the tubing in these conventional beverage forming systems is connected to a source other than water, and were allowed to sit uncleaned with residue for an extended period of time, bacteria would potentially be able to grow from the residue in the uncleaned fluid transfer lines between uses.

Hence, secondary reservoir 124 may contain such perishable liquids, and is configured so that it does not contact any of the primary reservoir 120 fluid transfer lines (water intake line 188, water pump exit line 186, water check valve 187, water pump 185, Y-connector 190, inlet line 189, fluid exit nozzle 135 or ring seal 136. No other conventional cartridge (pod) based beverage forming system on the market has been able to successfully address this design challenge, because each utilizes some type of micro water pump to transfer fluid from the reservoir (to a heating element, if applicable) and then on to a mixing chamber. Much like with the use of the primary reservoir 120, such a fluid transfer of perishable liquid would contaminate the fluid transfer lines and in particular, any fluid heating chambers where applicable.

The example secondary reservoir 124 as shown in FIG. 25 is able to connect directly to the pod 110 at the central opening 113. The secondary reservoir 124 may potentially apply pressure on both sides of its container 125 in order to “squeeze” the contents out to create a similar liquid-dispensing pressure effect to that normally generated by water pump 185. The method which contents are squeezed or forced out of the container 125 of the secondary reservoir 124 is not unique, it is that the container 125 can be used via direct connection to pod 110 to prevent contamination of the system fluid transfer lines.

Where the secondary reservoir 124 is selected for use, the fluid exit nozzle 135 and ring seal 136 would not be used. Instead, a ring shaped seal 126 on the container 125 is used to create a water tight seal with the central opening 113 after the upper hermetic seal 108A has been removed. An air inlet point 127 (directly on or inline directly to the ring shaped seal 126) may be used for pumping in air during the mixing process. In this way, the Y-connector 190 would be integrated directly into the ring shaped seal 126 (arranged directly above it). The container 125 of the secondary reservoir may thus be adapted to connect to the air inlet point 127, so as to use the existing system 100 tubing for the pumping of air while maintaining the sanitary integrity of all system 100—mounted fluid and air transfer lines.

Form factors for the container 125 of the secondary reservoir 124 could look like many well-known removably connected containers, including those more rigid in nature (e.g., like a milk jug/carton), or more flexible in nature like a liquid drink pouch (such as those known under the name CAPRI SUN®). Due to the liquid inside this removable secondary reservoir 124 being of a perishable nature, it will need to be kept refrigerated, and for that reason it would logically be intended as a single-use (or limited-use) liquid reservoir supply to prevent the growth of bacteria over time.

FIG. 26 is a right-side elevational view of the cross-sectional view of FIG. 9, which was taken across line C-C of FIG. 8 to illustrate potential placement of a secondary vacuum pump in more detail. Recall from above the issues with entrapped air being present at quantity within Y-connector 190 and the inlet line 189. Such air is to be minimized, which could be accomplished in more complex embodiments by using a vacuum air pump to suction out the air (create a vacuum, devoid of air particles) to prevent air particles from being the first thing pumped into the pod 110 at the beginning of the mixing cycle, thereby reducing the amount of dry powder expelled by the pod prior to the water entering hollow water vein 116. The purpose would be with a goal of increasing the rate/rapidness of beverage material wetting/saturation by decreasing the standing-air volume in-line ahead of the water. Use of a secondary suction air pump 192 connected to the fluid supply lines, specifically to the volume of empty space within Y-connector 190 and inlet line 189, could remove that issue.

However, this is not the only factor to consider in a complete mixing process of the beverage material 199 (powder), because even if the theoretical volume of air trapped inside Y-connector 190 and inlet line 189 were removed by the secondary suction air pump 192 of FIG. 26, and the water pump 185 were to be started properly before the air pump 180, the water would still perform saturation of the beverage material 199 in an manner consistent with the beverage material's distance away from the hollow water vein element 116.

Hence, another key factor in pod 110 design involves precisely setting the distance between the downward facing holes 119 at the bottom of the hollow water vein element 116 and the exit hole 115. FIG. 18 shows this positioning or setting of the of a distance from the exit hole 115 at the bottom of pod body 111 to the lower end or bottom of the water vein element 116 where the downward facing holes 119 are located. If the downward facing holes 119 on the water vein element 116 are too far away, the incoming volume of water (or water and trapped-air, in the event secondary suction air pump 192 is omitted) will displace any dry beverage material 199 closest to the exit hole 115 into the glass below, before it has ever been saturated; when this effect is dramatic enough, failures such as described above occur. If the downward facing holes 119 on the water vein element 116 are too close to the exit hole 115, the water pressure easily creates a path of least-resistance (“bottoming out”), and insufficient back-pressure will be created in the pod as water easily passes through to the exit point, resulting in the incomplete mixing of the rest of the beverage material 199 that is directly adjacent to exit hole 115.

Additionally, where there is too much space occupied by powdered beverage material 199 between the incoming water jets 106 exiting the water vein element 116 from the downward facing holes 119 and the exit hole 115 below, then the initial pressure from starting the mixing cycle will unavoidably cause dry powder to exit into the cup below, before any liquid solvent has a chance to saturate the powder mixture prior to it even being able to reach the exit hole 115. Since the region inside the pod body 111 between the downward holes 119 and the exit point 115 is the area of greatest turbulence, the rapid mixing zone (RMZ), it would be desirable to maximize this size of this RMZ, while avoiding failures due to too much dry powder exiting prematurely, which can create boundary layers that form in the cup below. Accordingly, this distance between the downward facing holes 119 and the exit hole 115, with or without the secondary suction air pump 192, is a critical factor to help to alleviate formation of these boundary layers.

FIGS. 27 and 28 are respective portional perspective and top plan views of the lower portion of the example pod 110 to illustrate a turbulence grid usable to increase fluid agitation while prepared beverage 199 exits the pod body 111 via the exit hole 115. FIG. 29 is a portional perspective view of the same lower portion of pod 110 to illustrate flow lines according to Bernoulli's equation principles for increasing prepared beverage exit velocity from the pod 110 via the exit hole 115.

The exit hole 115 may also have additional structure so as to assist with the exiting of the prepared beverage in a non-sporadic (non-errant) way. When the beverage material 199 is powdered material, the individual granules of powder will break away slightly-differently each time (much like the way each snowflake is “unique” due to the infinite chemical bond structure possibilities), there are moments when the beverage will be dispensing a more-viscous mixture, or a more-watered-down (less-viscous) mixture. This variability can cause errant spray from the exit hole 115 due to fluctuations in viscosity and corresponding pressure of the exiting mixed-fluid flow.

The result of this effect when using a basic circular exit hole 115 can be that beverage residue may spray errantly outside the rim of the cup situated within the receptacle area 150 below the mixing chamber 130. However, fluid dynamics may assist one in predicting a number of funneling techniques or structural changes to the exit hole 115 which could reduce this errant spray issue.

One such modification is to provide a geometric tip or feature (the form factor in this example is shown as an X-shaped feature 103 just above the exit hole 115), as shown in FIGS. 27 and 28. The X-shaped feature 103 serves as a turbulence grid for increasing fluid agitation to help break up clumps while prepared beverage (liquid solvent mixed with beverage material 199) exits the pod body 111 via the exit hole 115. The turbulence grid created by X-shaped feature 103 thus creates more hydrodynamic energy and additionally assists with making sure that any such clumps that form and which may be over a certain size (2 mm in this embodiment) are broken-up prior to being dispensed through exit hole 115.

Another factor or parameter is the tapering shape of pod body 111 down to its bottom end 114. This shape has an effect on fluid dynamics. Namely, and as a practical application of Bernoulli's principle, the tapering-down of the cross-sectional area above the exit hole 115 (see FIG. 29) causes an increase in the fluid exit velocity out exit hole 115. This velocity increase happens whether or not the X-shaped feature 103 is present, because it's driven by the pod body 111 shape or profile leading up to the exit hole (analogous to the shape of an airplane turbine affecting fluid dynamic flow). The increasing fluid exit velocity subsequently reduces the errant spray that may be produced by momentary changes in exiting beverage mixture viscosity.

Additionally, other static turbulent flow creating structures could be placed strategically internally or near (slightly above) the exit hole 115 so as to assist with smooth dispensing of the fluid, and to further assist in the mixing process. This additional mixing would occur by forcing the pressurized fluid mixture over the static shapes internally within the pod body 111. The internal hydrodynamic turbulence created by such static structures is the same fundamental application of principles which causes hollow water vein 116 to be an effective energy substitute for mechanical agitation. The primary difference being that in FIGS. 27 and 28, the fluid that is passing over the turbulent flow creating structure (the “X” shaped feature 103) is a more viscous beverage/fluid mixture, rather than a less-viscous unmixed (water) fluid solvent that is being initially pumped in from the primary reservoir 120 and been pressurized by water pump 185 to be dispensed out of the water vein element 116.

But using one type of turbulence generating structure for hydrodynamic energy creation alone (without other types) does not constitute an advancement in fundamental design for hydrodynamic mixing methods, but rather a selective application of the principles and framework disclosed herein. The water vein element 116 is the primary structure which is designed to create turbulent flow in the example embodiments, but such structure could be adjusted to include X-shaped feature 103 or to instead use X-shaped feature alone, or any other static internal structure, as the primary structure which is designed to create turbulent flow.

The arrangement of this structure (X-shaped feature 103 serving as a turbulence grid) near the exit hole 115 will also help to hold-back the powder material from spilling out once the bottom hermetic seal 108B has been removed prior to mixing. Since >1% insoluble beverage material powders are so prone to clumping, these powders do not spill out of the exit hole 115 after the lower hermetic seal 108B is removed.

Similar beverage pods that may contain powdered sugar-based drinks would be more susceptible to leaking powder out the bottom upon removal of the lower hermetic seal 108B (another factor demonstrating that >1% insoluble beverage powders have unique properties) so a finer-mesh sieve pattern than what is shown in FIGS. 27-28 could be used to help retain these less-compactable dissolvable powders for applications which behave in a more sandy granular-like powdered nature, rather than easily clumping and compacting >1% insoluble beverage powder materials (materials that are primarily protein-based and/or are foodstuff derived powders).

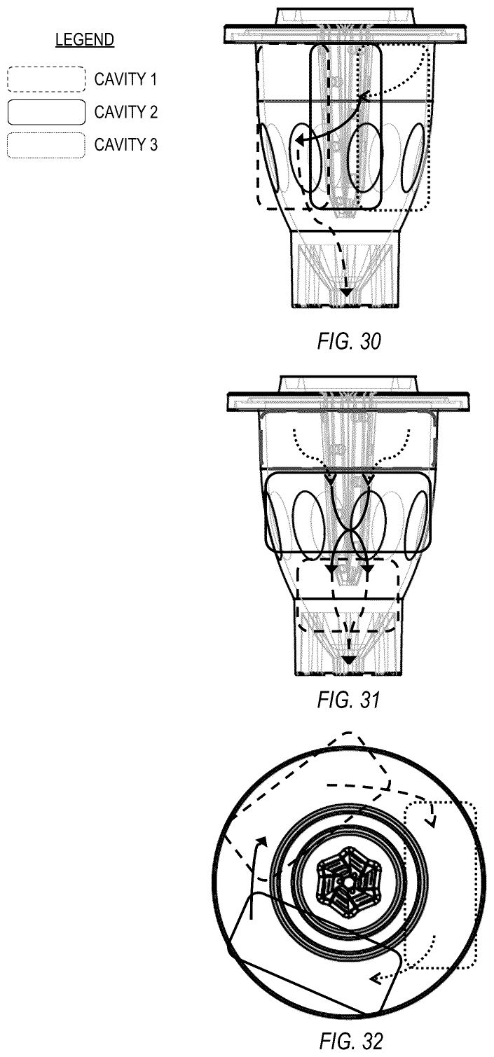

Another example embodiment is directed by a pod design with multiple cavities or chambers therein. FIGS. 30 to 32 show two different example multi-cavity pod constructions. Namely, the pod body 111 (which is the mixing container itself) could be situated within multiple internal cavities to perform the mixing process. In this example, each internal cavity is designed to mix its portion of the beverage material serving. An alternative embodiment could pass the beverage material 199 from a beginning chamber to an end chamber, further mixing it along the way as it ports through to an ultimate exit hole 115.

The orientation of cavities could be top-to-bottom FIG. 31 or axially around the interior of the pod as shown (FIGS. 30 and 32). Since the example embodiments demonstrate how to generate an excess of hydrodynamic energy within the pod body to use for mixing beverage material via turbulent fluid flows, numerous other turbulence-generating structures in addition to, or in place of, water vein element 116 and pod body 111 are contemplated which form an air-tight container when sealed at the central opening 113/ring seal 136 interface. Several cavities within a given pod interior could be used to pass fluid mixture therethrough, prior to dispensing out exit hole 115. In this example, each cavity may further generate turbulence and mix beverage material more thoroughly as the mixed slurry progresses closer to the exit hole 115.

Each of the envisioned turbulent generating structures exist at connection-points between cavities in this multi-cavity pod embodiment, so that passing a slurry mix from cavity-to-cavity will act much like an internal turbulence-grid. Not all of the powder may be instantly saturated in a multi-cavity construction, and may be dependent in part on one or more of the overall pod size, method/plan for initially wetting the beverage material, properties of the beverage material, and physical configuration of the cavities.

In addition to the non-expandable single-serving pod 110 described with reference to FIGS. 5-23 and 26-29, expanding volume pods may be utilized in the beverage forming system 100 to enable the achievement of more consistent results for smooth hydrodynamic mixing of beverage material such as hydrophilic powders and the like. The expandable pod version permits a beverage material such as a powder to shift or move inside the expanding pod; this promotes the natural separation of powder molecules, reducing the amount of clumping observed and preventing the tendency for boundary layers to form on inside walls of the pod.

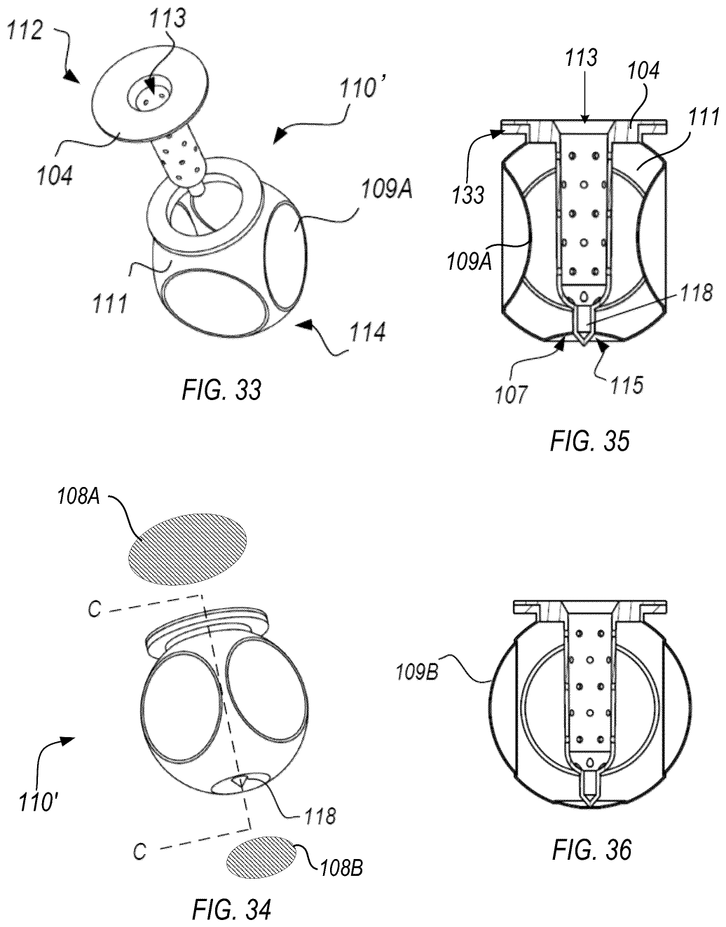

FIG. 33 is a partial exploded parts perspective view of an expandable pod 110′ according to another example embodiment in order to show its upper flange 104 and water vein element 116 in more detail. FIG. 34 is another perspective view of the pod 110′ of FIG. 33 with hermetic seals separated. Referring now to FIGS. 33 and 34, there is shown an expandable pod 110′ according to another example embodiment. As this expandable pod 110′ was described in Applicant's priority '907 application, only selected features are discussed in detail herein. Expandable pod 110′ has the general same construction as pod 110, but the water vein element 116 has a distal tip that is embodied as a spike 118. Spike 118 is designed to pierce through the bottom end 114 of pod 110 to create the exit hole 115.

In one example, a portion of (or all of) the expandable pod 110′ may be composed of thin food-safe vacuum formable, blow-moldable, or injection molded plastic(s). The plastic may be malleable so that the entire expandable pod 110′ is capable of plastically deforming and rebounding by a small amount, but the spike 118 remains stiff enough to puncture the lower hermetic seal 108B at the bottom end 114 of the expandable pod 110′ to create the exit hole 115. The expandable pod 110′ thus remains sealed throughout the entire mixing process in every place but at the punctured exit hole 115. An easily removable upper hermetic seal 108A, such as a thin tin foil, wax or paper seal, may be used to protect and maintain the central opening 113 to keep the water vein element 116 protected and food-safe during storage and distribution.

Pod body 111 is adapted to be capable of articulating from concave form factor to a convex or spherical form factor under pressure, and in that form is punctured or vented so as to release mixed beverage contents via exit hole 115 into a cup placed in the cup receptacle area 150. In this example, expandable pod 110′ can be in any shape, and water vein element 116 can have different combinations of holes 117, which may be cut or formed into the body of the water vein element 116 that is within the closed interior space of pod body 111, so as to generate different spray patterns. The form factors shown in FIGS. 33-36 may promote successful mixing for difficult-to-mix hydrophilic protein powders as described herein.

FIG. 35 is a cross-sectional view taken across line C-C of FIG. 34 to show the expandable pod 110′ in a pre-expansion state; and FIG. 36 is another cross-sectional view taken across line C-C of FIG. 34 and which is similar to FIG. 35, but shows the pod 110′ after pressurization.

Once placed in the front-loading mixing chamber 130, (such as previously shown in FIGS. 7 to 9), the central opening 113 in the middle position of flange 104 at the top end 112 is sealed to the fluid exit nozzle 135 via nozzle-shaped ring-seal 136. As seen best in FIGS. 35 and 36, expandable pod 110′ may include concave cavities 109A that revert to convex features 109B upon the pod 110′ being pressurized by the water pump 185 and the air pump 180 during the mixing process.

In particular, FIG. 35 shows the expandable pod 110′ in its pre-expansion state, after it has been pierced at its bottom end 114 by the spike 118 of the water vein element 116, but prior to pressurization to expand the pod 110′ into a spherical or convex shape for the mixing process. The concave form factor is also functionally designed to have a rectangular cross section, which helps to reduce its over footprint and size, decreasing packaging costs and reducing space requirements during storage and transportation.

FIG. 36 specifically illustrates the conversion of concave cavities 109A to convex features 109B. This occurs after pressurized expansion due to internal pod 110′ pressures, with the expandable pod 110′ in a state such that the prepared beverage within body 111 is now able to flow out of the exit point 115 created by the spike 118. Additionally, the concave cavity 109A which turns into a convex feature 109B also allows space for the internal beverage material 199, such as protein powder, to spread out inside the body 111 of pod 110′ during the initial mixing process, promoting clump-free mixing that can still occur while achieving the cost saving benefits of lower overall requirements for shipping and storage volumes.

The water vein element 116 in the upper portion or top end 112 incudes the aforementioned plurality of radial holes 117 in spaced relation to one another along and around the water vein element 116 so that, once a mixing process has been initiated and the sealed central opening 113 is connected to the fluid exit nozzle 135, a pattern of water jets 106 is created due to pressurized water from the water pump 185 (and air pump 180) entering the water vein element 116. This will create turbulent flow within the closed interior space of pod body 111 to promote mixing of the pressurized liquid with the beverage material therein, as previously noted above. Air will also begin to accumulate in the upper portion of body 111, slowly forcing the mixed and hence prepared beverage downward through the created exit hole 115 into the cup receptacle area 150 that is positioned directly below the mixing chamber 130.

Operation is similar to the previous embodiment, where pressurized liquid 105 fills the hollow water vein element 116 and exits radial holes 117 as water jets 106. The internal pressure within the expandable pod 110′ causes the concave cavity 109A walls thereof to protrude outward into the convex feature 109B form factor (or spherical form factor), giving the beverage material 199 new space to move into as it mixes with the incoming pressurized liquid prior to being dispensed out exit hole 115.

The water pump 185 continues to fill pod body 111 until the internal pressure causes all of the loose beverage material 199 (such as protein powder) to be forcefully saturated within the initial seconds of the water pump 185 running. Simultaneous to the beverage material 199 becoming forcefully saturated, the expandable side walls of the pod body 111's internal cavity pop outward under the internal pressure of the incoming pressurized liquid 105.

The internal pressure inside the expandable pod 110′ grows to a point where the bottom end 114 of expandable pod 110′ is pushed downward/outward again so that the spike 118 is quickly retracted from the formed exit hole 115, as previously described in Applicant's '907 application. This facilitates the initial significant flow rate of prepared beverage out of the exit hole 115. Moreover, the retraction of the dimple feature 107 at the bottom end 114 as the spike 118 is retracted from the exit hole 115 releases pressure facilitating additional turbulent flow in the previously unoccupied volume around the profile of the spike 118 and around bottom end 114 in the interior space of pod body 111 via the downward facing water jets 106 formed out radial holes 117, which further agitate the newly saturated beverage material. In other embodiments, the hollow water vein element 116 with the distal tip spike 118 may be articulated by a well-known DC component such as a solenoid or linear actuator to execute the puncture and retraction that form the exit hole 115.

The rapidly mixed prepared beverage (due to turbulent flow of the pattern of water jets 106 emitted from the holes 117 on water vein element 116) exits through the vent path created at exit hole 115 by the spike 118. This turbulent flow within the closed interior space of pod body 111 promotes mixing of the pressurized liquid with the beverage material 199 therein, as previously noted above. Air will also begin to accumulate in the upper portion of body 111, slowly forcing the mixed and hence prepared beverage downward through the created exit hole 115, being dispensed as the prepared beverage into the user's cup below in cup receptacle area 150. The water pump 185 also stops at the end of the mixing period based on the desired liquid volume selected by the user, which removes pressure that is then compensated for by the air pump 180 which runs until the expandable pod 110′ has drained fully and no longer has any liquid contents remaining.

Like the previous embodiment, some of these radial holes 117 port water jets 106 directed radially straight out from the side of the water vein element 116, other angular holes 117 on angled/rounded surfaces of the water vein element port angular water jets 106, and downward water jets are ported out from holes 119 (not shown) that may be adjacent and along spike 118, creating turbulent flow in the RMZ near the formed exit hole 115 so as to agitate the beverage material additionally upon exiting expandable pod 110′, thereby further deterring clumping and preventing clogging near the exit hole 115.

Accordingly, there are two separate turbulent flow conditions that promote complete mixing in this expandable pod 110′ embodiment: (a) the turbulent flow generated by the radial holes 117 and the downward/outward water jets 106 exiting water vein element 116, and (b) the turbulent flows created by the rapidly displaced material and the mixed beverage exiting from inside of the expandable pod 110′ that begins immediately after the spike 118 is retracted from the exit hole 115 made via puncturing the bottom end 114 thereof. The turbulence provided by the pressurized flowing water in both conditions thus results in an energy substitute for various other types of agitation, including any of mechanical, thermal, chemical, gravity-based agitation and the like, which is not employed in system 100 for purposes of mixing beverage material with the pressurized liquid.

Accordingly, pod 110′ with its internal beverage material 199 contents is expandable, single-use and multi-purpose (not just for hydrophilic powders/protein powders, but also may be used for other powdered beverages). Pod 110′ serves as the storage/delivery method for the dry beverage material 199, as well as the physical mixing container for the mixing process that produces the single serving of prepared beverage. Body 111 of pod 110′ thus serves as the location for the pressurized water 105 (such as shown in FIG. 22) to merge with the beverage material 199, and its expanding form factor of body 111 cooperates with various parameters of the system 100 to regulate pressure and promote turbulent flow at the right moment.

This turbulent flow as described herein (due to the hydrodynamic energy created within body 111) agitates the dry beverage material 199 and the pressurized liquid 105 exiting holes 117 and 119 as a pattern or array of water jets 106 into a saturated (and hence dissolved/dispersed) prepared beverage without clumping. The prepared beverage is then dispersed as a homogenous mixed prepared beverage solution therefrom into a drinking vessel such as a cup, mug, glass, etc., Although there may be slight residue remaining after venting the mixed prepared beverage contents from pod body 111 into the cup, (which may be resting on an adjustable height platform in cup receptacle area 150), the turbulent flow provided by the pattern of water jets 106 facilities near-complete mixing, whereby almost all of the contents within body 111 of the pod 110′ are washed out completely upon completion of venting through the exit hole 115 formed by spike 118 penetration.

In either pod 110/110′ embodiment, the beverage material 199 takes up between about 66.6% to 95% of the starting volume in pod 110/110′ prior to the mixing process, with less than half of the interior space volume left free for promoting clump-free mixing and deterring beverage material 199 from getting stuck to the top underside surface (see interior surface of flange 114 at top end 112) of the pod 110/110′. Like the previous embodiment, air pump 180 pumps additional air through food-grade air filter 181 in the exit line 183 and up through Y-connector 190, out exit nozzle 135 and into the water vein element 116 of the expandable pod 110′ during the mixing process to further force the prepared beverage from mixing downward and prevent any residue issue. As in the previous embodiment, after the water pump 185 has run its full cycle and is turned off, air from air pump 180 is pumped into the pod 110′ to complete the draining process of the prepared beverage into the drinking vessel.

In general, and applicable to each pod 110/110′ embodiment useable with system 100, the water pump 185 may be configured so as to have a minimum pump pressure threshold of 7 psi (e.g., ≥7 psi mean pressure or ≥0.5 bar). Further, pod 110/110′ form factors and corresponding air pump 180 and water pump 185 runtimes (cycle times) for each pod type are specifically designed to allow the pod 110/110′ to be properly pressurized with fluid to promote turbulent flow and mixing.

In some embodiments, pod 110′ (like pod 110) is intended to be single-use and disposable to prevent the potential for bio-contamination caused by improperly cleaned reusable containers. This is especially true for nutritional powders such as protein powder, because a protein powder has a tendency to clump, stick to walls, and otherwise leave a bio-film type residue which a user must physically scrub off. In alternate constructions, pods 110,110′ may be a recyclable single-use pod, or may be a reusable and recyclable pod.

The single-serving pod-based design of this beverage mixing system 100 is unique to other options for mixing protein powders because the solution requires zero clean-up (aside from recycling/discarding the empty pod). All this is accomplished without any mechanical agitation. Compare this to the GUDPOD™ product, which uses mechanical agitation through an inverted blender-motor. GUDPOD requires this because their solution employs disposable blender tines formed into an ornamental pod-like shape, together with a proprietary cup that must be used with their disposable containers, which needs to be cleaned before every use. Conversely, the present solution does not have any parts that must be cleaned prior to each use, and it works with any cup or bottle provided by the user in cup area 150.

The pressurization of water via hydrodynamic energy to create the turbulence conditions thus replaces all other forms of agitation noted above, while recreating predictable scenarios of fluid dynamics within either pod 110 or pod 110′ on a consistent basis so that adequate mixing is consistently ensured. As in the previous pod 110 embodiment shown in FIGS. 11-23, the placement and patterns of the water jets 106 via the radial holes 117 in the water vein element 116 are thus strategically distributed across the entire inner volume of the expandable pod 110′. Therefore, within the expandable pod 110′ additional turbulent flow is created by the forced water flow around the spike 118 at the bottom end 114 thereof, in addition to that caused by the pattern of water jets 106, to substantially mix the beverage material and pressurized liquid in forming the prepared beverage. Moreover, the cup filling time with the prepared beverage, upon initiation of the mixing process, is variable depending on the composition of the beverage material within the closed interior space of the body 111 of expandable pod 110′ and the expandable form factor thereof.

In another example, system 100 may be configured to include or incorporate either (a) a thermal element to heat the water (or other fluid) to be pressurized and ported into the open end of the water vein element to make the prepared beverage, (b) a cooling element which chills the water or other fluid prior to it entering the mixing chamber 130, or may include both options (a) and (b). Neither the use of secondary thermal heating or a secondary cooling element are critical to the hydrodynamic mixing method of the beverage material 199 with the pressurized liquid 105 within the hollow interior body 111. Examples of (a) are prevalent in the beverage forming system; examples of (b) may include use of a peltier cooler and/or a small refrigerated reservoir. Consumers of protein beverages often prefer their drinks cold, and often describe that the perceived taste is improved when the beverage is cold.

While the example embodiments describes the beverage material 199 as a protein powder drink substance packaged into a pod 110, the interior dry contents of pod 110 could alternatively include any of the previously mention beverage material equivalents, including but not limited to: sugared powdered drinks, kids' drinks, energy powders, melatonin (and other sleep-aid) powders, plant-based shakes and foodstuff beverages, pre-workout and post-workout formulas, other nutritional supplements, and vitamin substances, etc.

In another example, each of the mixing time periods within body 111 of the pod 110/110′ (cycle times of pumps 180, 185) and form-factor of the pod body 111 may vary, depending on the type and composition of beverage material 199 within the interior thereof. This is because the composition of some beverage materials 199 may have particles that are easier to mix or dissolve, or may be more hydrophilic than others, thus potentially requiring more or less time and custom parameters during mixing and saturation process to properly mix the beverage material 199 with the pressurized liquid 105 to ultimately vent via exit hole 115.

In an alternative example, the beverage material 199 may include a liquid soluble concentrate instead of a powder which is mixed using the mixing process described above. This is in contrast to conventional post-mix beverage forming machines commercially available, because here water/liquid is being introduced to a fully self-enclosed container for mixing to occur inside the pod 110/110′, which already contains the liquid concentrate in a single-serving amount, as opposed to using a metered-mixing approach.

In another alternative example, the beverage material 199 may include an oil concentrate or other liquid non-soluble contents for complete dispersal to create an insoluble mixed solution prior to dispensing it into the user's cup, while leaving only minimal residue inside of the pod 110/110′. Various oil concentrates can be used to deliver a number of benefits, and because many of these oil concentrates are not water soluble nor easily dissolved/diluted, a custom-designed pod 110 and water vein element 116 could be implemented in this variant to mix the two insoluble solutions without mechanical agitation.

Water vein element 116 has heretofore been described as fixed in place, attached to flange 104 or otherwise embodied as a one-piece molded article with flange 104. However, in an alternative example, the hollow water-vein element 116 may be configured so as to spin relative to the pod body 111 with its beverage material 199 inside. This is distinguished from a mechanical agitation solution (or any of thermal, chemical, vibrational, gravity-based agitation and the like agitation solutions, for that matter) which uses a physical agitator having motion energy that physically collides into a fluid, which propels the fluid forward into motion itself (much like a car collision, where the kinetic motion energy is violently transferred from one fast-moving object to a stationary one).

Here, the spin-able water vein element 116 retains the radial holes 117 and downward facing holes 119 that use the liquid solvent (pressurized liquid 105) to produce the pattern or array of high pressure water jets 106, which in-turn transfer hydrodynamic energy into the solute/solvent particles to propel the fluid mixture into motion. However, since in this variant the water vein element 116 is spinning in place, it is not transferring motion energy via physical collision like a blender would, but instead produces moving/mobile water jet streams within pod body 111 that generate the hydrodynamic energy proven (as described throughout this disclosure) to be highly effective at mixing.

Recall also the “shower head” form factor variant for the plurality of radial holes 117 in water vein element 116, in which the corresponding shape for the pod body 111 would be as a thin flat disk of relative uniform-thickness positioned adjacent to a companion hollow water vein “disk”. This alternative construction could similarly be used in a spinning fashion over the top of a pre-loaded serving of beverage material 199 within the pod body 111 interior, with the mobile water jets 106 moving out of holes 117, 119 relative to the static beverage material 199, and where the spinning hollow water vein disk makes absolutely zero contact with the beverage material 199 therein.

This alternative design where the hollow water vein element 116 is spinning while under water pressure leverages the additional forces of inertia due to the spinning momentum carried by the distributed pattern of water jets 106, which has more free-energy to transfer into the mixture. This may prove to be another advantageous functional benefit for the efficacy of mixing that is beyond that capable from use of a static or fixed water vein element 116 as shown in the example embodiments.

Although the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures to those claimed, whether or not such alternate, interchangeable and/or equivalent structures disclosed herein, and without intending to publicly dedicate any patentable subject matter.

I claim:

1. A pod arranged for use in a beverage forming system to make a prepared beverage solely by hydrodynamic mixing of a beverage material subject to clumping with a pressurized liquid introduced into the pod by the beverage forming system, comprising:
a body having a top end, bottom end, and an interior space, and
an elongate water vein element having a hollow interior and disposed within the interior space for receiving the pressurized liquid used for hydrodynamic mixing, an upper end of the water vein element having a central opening aligned with an opening in the beverage forming system that, upon initiation of a mixing process, provides access for the pressurized liquid to flow into the hollow interior of the water vein element, the pressurized liquid exiting the water vein element into the interior space of the body as an array of water jets, creating hydrodynamic-based kinetic energy to impart turbulent flow within the interior space so as to rapidly saturate the beverage material and form the prepared beverage prior to any forming of clumps in the beverage material, wherein
the body includes an exit hole at the bottom end thereof, the prepared beverage vented through the exit hole into a cup arranged beneath the pod in the beverage forming system.

2. The pod of claim 1, further comprising a flange element attached to the upper end of the water vein element and containing the central opening therein through which the pressurized liquid for hydrodynamic mixing flows into the hollow interior of the water vein element, the flange element additionally serving as a rim of the pod to facilitate alignment of the pod body into a mixing chamber of the beverage forming system.

3. The pod of claim 1, wherein the pod is selected from a group comprising a disposable single-use pod, a recyclable single-use pod, and a reusable and recyclable pod.

4. The pod of claim 1, wherein the beverage material is a powder-based beverage material comprising any of juice powder mixes, vitamin mixes, sports drink powder mixes, instant coffee mixes, and other beverage materials which are over 99% soluble in water.

5. The pod of claim 1, wherein the beverage material is a powder-based beverage material comprising any of protein powders, other nutritional powders, and foodstuff powders that are less than 99% soluble when mixed in a liquid to form a prepared beverage.

6. The pod of claim 1, wherein the beverage material is embodied as a liquid-based beverage material comprising solids suspended or precipitated within water and any beverage material greater than 1% water insoluble when mixed in water to form a prepared beverage.

7. The pod of claim 1, wherein the water vein element includes a plurality of holes arranged in spaced relation to one another along a longitudinal plane of the water vein element from top to bottom thereof, as well as around a circumference of the water vein element from top to bottom thereof, the pressurized liquid exiting the plurality of holes as the array of water jets that create the hydrodynamic-based kinetic energy to impart the turbulent flow into the interior space of the body of the pod.

8. The pod of claim 7, wherein a radial distance from each of the holes in the hollow water vein element to an interior side surface of the pod is approximately equal, with an exception of any holes facing downward toward the exit hole, to facilitate complete uniform saturation of the beverage material by the array of water jets.

9. The pod of claim 7, wherein a vertical distance between the bottom of the water vein element and an exit point for the prepared beverage at the exit hole is optimized to create a rapid mixing zone for complete mixing, thereby avoiding improper mixing where dry beverage material exits into the cup or a boundary layer is created within the prepared beverage in the cup.

10. The pod of claim 7, wherein complete mixing of the beverage material with the array of water jets is a function of spacing between holes in the water vein element, a size diameter of the holes, water jet velocity out each hole, and overall liquid fluid flow rate of the pressurized liquid exiting the water vein element.

11. The pod of claim 1, wherein the body further includes multiple separate cavities within its interior space where hydrodynamic mixing of the beverage material and pressurized liquid occurs.

12. The pod of claim 1, wherein various ones of the array of water jets are configured to shoot radially outward at multiple locations from sides of the water vein element, downward at multiple locations from the water vein element sides at an angle relative to a horizontal plane therethrough toward the pod bottom end, and directly downward at multiple locations from the bottom of the water vein element toward the exit hole.

13. The pod of claim 1, wherein the exit hole includes a turbulence generating feature formed therein which creates additional hydrodynamic energy with in the body of the pod to assist in breaking up any clumps in the prepared beverage that form prior to being dispensed through the exit hole.

14. The pod of claim 1, wherein the body of the pod has a tapering shape that narrows down toward the exit hole so as to increase fluid flow velocity of the prepared beverage as it is dispensed out of the pod into the cup.

15. The pod of claim 1, wherein the body of the pod is rigid or expandable.

16. A pod arranged for use in a beverage forming system to make a prepared beverage solely by hydrodynamic mixing of a liquid solute with over 1% insoluble content with a pressurized liquid that is introduced into the pod by the beverage forming system, comprising:
a body having a top end, bottom end, and an interior space, and
an elongate, water vein element having a hollow interior and disposed within the interior space, for receiving the pressurized liquid used for hydrodynamic mixing, a top open end of the water vein element aligned with an opening in the beverage forming system that, upon initiation of a mixing process, provides access for the pressurized liquid to flow into the hollow interior of the water vein element, the pressurized liquid exiting the water vein element into the interior space of the body as an array of water jets creating hydrodynamic-based kinetic energy to impart turbulent flow within the interior space to agitate the liquid solute with over 1% insoluble content and form the prepared beverage, wherein
the body includes an exit hole at the bottom end thereof, the prepared beverage vented through the exit hole into a cup arranged beneath the pod of the beverage forming system.

17. A beverage forming system to make a prepared beverage solely by hydrodynamic mixing of a pod containing a beverage material subject to clumping within an interior space of a body of the pod with a pressurized liquid introduced into the interior space thereby, comprising:
a housing,
at least one reservoir attached to the housing and containing a liquid therein,
a mixing chamber accessible on the housing for loading the pod containing the beverage material therein, the pod body having a central opening at a top end thereof and an exit hole in a bottom end thereof, the mixing chamber connected to a source that pressurizes the liquid drawn from the at least one reservoir for hydrodynamic mixing of the pressurized liquid and the beverage material within the interior space, and
a platform in the housing for supporting a cup directly beneath the mixing chamber, wherein
the pressurized liquid, when introduced into the central opening of the pod body, forms an array of water jets that creates hydrodynamic-based kinetic energy to impart turbulent flow within the pod to rapidly agitate the beverage material and form a uniformly dispersed prepared beverage that is vented through the exit hole into the cup on the platform.

18. The beverage forming system of claim 17, further comprising:
a water pump which serves as the source of the pressurized liquid, and
an air pump that provides additional pressurized air into the pod along with the pressurized liquid into the pod so as to assist with draining of the pod into the cup on the platform.

19. The beverage forming system of claim 18, wherein the pressurized air creates air bubbles inside the array of water jets and beverage material mix that cavitate inertially and non-inertially transfer energy into the prepared beverage.

20. The beverage forming system of claim 17, further comprising:
an air pump configured to provide pressurized air through the mixing chamber and pod body top end into the interior space, the pressurized air ported into the interior space during and after completion of a pressurized liquid cycle, and
the pressurized air adapted to force the beverage material mixing with the array of water jets within the interior space of the pod body downward toward the exit hole so as to prevent clogging of the exit hole and to deter any residue still within the interior space.

21. The beverage forming system of claim 17, wherein the pod does not require any other internal or external source of mechanical, thermal, vibrational, and aerodynamical kinetic energy, in addition to hydrodynamic kinetic energy, for agitation of the beverage material with the array of water jets to induce mixing thereof so as to create the prepared beverage.

22. The beverage forming system of claim 17, wherein
the at least one reservoir includes a removable primary reservoir alone for housing water to be pressurized, or the primary reservoir and a removable secondary reservoir, and
the secondary reservoir is configured to house a perishable, non-water liquid therein and port a pressurized perishable, non-water liquid directly to the central opening in the pod so as to avoid contamination of any system fluid transfer lines between the water pump and the central opening.

23. The beverage forming system of claim 17, further comprising a secondary vacuum air pump configured to minimize any air entrapped in a fluid line through which the pressurized liquid flows into the central opening of the pod within the mixing chamber.
